(19) United States
(12) Patent Application Publication
(10) Pub. No.: US 2014/0170406 A1
(43) Pub. Date: Jun. 19, 2014

(54) RESIN FOAM AND PROCESS FOR PRODUCING THE SAME

(71) Applicants: Hironori Yasuda, Ibaraki-shi (JP); Mitsuhiro Kanada, Ibaraki-shi (JP); Yoshinori Kouno, Ibaraki-shi (JP); Mie Ota, Ibaraki-shi (JP); Yuko Kandori, Ibaraki-shi (JP)

(72) Inventors: Hironori Yasuda, Ibaraki-shi (JP); Mitsuhiro Kanada, Ibaraki-shi (JP); Yoshinori Kouno, Ibaraki-shi (JP); Mie Ota, Ibaraki-shi (JP); Yuko Kandori, Ibaraki-shi (JP)

(73) Assignee: NITTO DENKO CORPORATION, Ibaraki-shi, Osaka (JP)

(21) Appl. No.: 14/236,678

(22) PCT Filed: Jul. 24, 2012
(86) PCT No.: PCT/JP2012/068680

§ 371 Date: Feb. 3, 2014

(30) Foreign Application Priority Data
Aug. 2, 2011 (JP) 2011-169624
Aug. 2, 2011 (JP) 2011-169625
Jul. 20, 2012 (JP) 2012-161060

(51) Int. Cl. C08L 33/00

(52) U.S. Cl. CPC C08L 33/00
USPC 428/220; 521/138

(57) ABSTRACT

A resin foam has a thickness recovery rate (23° C., one minute, 50% compression) of 70% or more and a strain recovery rate (80° C., 24 hours, 50% compression) of 80% or more. The thickness recovery rate is determined by compressing the resin foam, holding the resin foam in the compressed state, decompressing the resin foam, measuring a thickness of the resin foam one second after the decompression, and calculating a percentage of the measured thickness with respect to the initial thickness as the thickness recovery rate. The strain recovery rate is determined by compressing the resin foam, holding the resin foam in the compressed state, returning the resin foam to 23° C. while maintaining the compressed state, decompressing the resin foam, and determining a percentage of a recovered distance with respect to a compressed distance as the strain recovery rate.

### TECHNICAL FIELD

The present invention generally relates to resin foams and processes for producing the resin foams. Specifically, the present invention relates to resin foams and processes for producing the resin foams, which resin foams are useful typically for or as internal insulators in electronic appliances and other articles, cushioning materials, sound insulators, heat insulators, food packaging materials, clothing materials, and building materials.

### BACKGROUND ART

Some foams have been used typically for or as internal insulators in electronic appliances and other articles, cushioning materials, sound insulators, heat insulators, food packaging materials, clothing materials, and building materials. These foams should be flexible and excel in properties such as cushioning properties and heat insulating properties so as to provide good sealability upon assemblage as components. Among foams, thermoplastic resin foams typified by foams of polyolefins such as polyethylenes and polypropylenes are well known. These foams, however, disadvantageously have low strengths and are inferior in flexibility and cushioning properties. In particular, when compressed and held in the compressed state at high temperatures, they disadvantageously exhibit poor strain recoverability, resulting in inferior sealability. An attempt to improve such poor strain recoverability has been made by incorporating, for example, a rubber component into a material resin to impart elasticity thereto. This allows the material resin itself to become flexible and to exhibit restitution due to the elasticity and contributes to better strain recoverability. The resulting foam, however, exhibits a low expansion ratio although generally having better restitution by the action of elasticity of the incorporated rubber component. This is because, once the resin undergoes expansion and deformation by the action of a blowing agent to form a cell structure in a foam production process, the cell structure thereafter contracts due to the restitutive force (resilience) of the resin.

Customary processes for the production of foams are generally represented by chemical processes and physical processes. A common physical process involves dispersing a low-boiling liquid (blowing agent), such as a chlorofluorocarbon or a hydrocarbon, in a polymer and then heating the dispersion to volatilize the blowing agent to thereby form cells (bubbles). A chemical process involves adding a compound (blowing agent) to a polymer base, thermally decomposing the compound to evolve a gas, and thereby forming cells to give a foam. However, the physical foaming technique causes various environmental disadvantages such that the substance to be used as the blowing agent may be harmful and may deplete ozonosphere. The chemical foaming technique disadvantageously suffers from contamination of a corrosive gas and impurities remaining in the foam after expansion; but such contamination is undesirable particularly in electronic components and other applications where the contamination should be minimized or prevented.

A technique for obtaining a foam having a small cell diameter and a high cell density has been recently proposed. This technique involves dissolving a gas such as nitrogen or carbon dioxide in a polymer under high pressure, subsequently decompressing the polymer (releasing the polymer from the pressure), and heating up the polymer to the vicinity of the glass transition temperature or softening point thereof to form cells. The foaming technique advantageously gives a foam having a micro cell structure, in which nuclei are formed from a thermodynamically unstable state, and expand and grow to form cells. In addition, various attempts have been proposed to apply the foaming technique to thermoplastic elastomers such as thermoplastic polyurethanes so as to give flexible foams. Typically, a process is known in which a thermoplastic polyurethane resin is expanded by the foaming technique to give a foam having uniform and micro cells and being resistant to deformation (see Patent Literature 1).

The foaming technique, however, disadvantageously fails to provide a foam with a sufficient expansion ratio. Specifically, according to the foaming technique, the gas (e.g., nitrogen or carbon dioxide) forms nuclei, and the nuclei expand and grow after decompression to reach an atmospheric pressure and form cells in which the gas remains. The foaming technique once gives a foam with a high expansion ratio. However, the gas (e.g., nitrogen or carbon dioxide) remaining in the cells gradually passes through the polymer cell walls, and this causes the foam to contract. The cells thereby gradually deform and/or contract to fail to maintain such a sufficiently high expansion ratio.

In contrast, proposed is a technique of preparing, as a material, a thermoplastic resin composition incorporated with an ultraviolet-curable resin; expanding the resin composition; and curing the ultraviolet-curable resin by forming a crosslinked structure after expansion (see Patent Literature 2).

### CITATION LIST

### Patent Literature

Patent Literature 1: Japanese Unexamined Patent Application Publication (JP-A) No. H10-168215

Patent Literature 2: JP-A No. 2009-13397

### SUMMARY OF INVENTION

### Technical Problem

Resin foams recently increasingly require various properties according to intended uses. Typically, the resin foams increasingly require excellent dust-proofness even at high temperatures, excellent impact absorption even at high temperatures, and/or superior heat resistance. In addition, demands have been made to provide resin foams that are highly resistant to heat, are satisfactorily flexible, and can block light effectively. The foam disclosed in Patent Literature 2, however, may be insufficient for these requirements.

Accordingly, an object of the present invention is to provide a resin foam that exhibits excellent dust-proofness even at high temperatures.

Another object of the present invention is to provide a resin foam that can satisfactorily absorb impact even at high temperatures.

Yet another object of the present invention is to provide a resin foam that is highly resistant to heat.

Still another object of the present invention is to provide a resin foam that is highly resistant to heat, is satisfactorily flexible, and can effectively block light.

### Solution to Problem

After intensive investigations to achieve the objects, the present inventors have found that a resin foam exhibiting excellent dust-proofness even at high temperatures can be obtained by allowing the resin foam to have a thickness recovery rate (23° C., one minute, 50% compression) at a specific level or more and a strain recovery rate (80° C., 24 hours, 50% compression) at a specific level or more.

They have also found that a resin foam capable of satisfactorily absorbing impact even at high temperatures can be obtained by allowing the resin foam to have a variation in impact absorption rate at a specific level or less.

They have further found that a resin foam being highly resistant to heat can be obtained by allowing the resin foam to have a rate of dimensional change at a specific level or less after left stand at an ambient temperature of 200° C. for one hour and to have a rate of weight change at a specific level or less after left stand at an ambient temperature of 200° C. for one hour.

In addition, they have found that a resin foam being highly resistant to heat, satisfactorily flexible, and capable of effectively blocking light can be obtained by allowing the resin foam to have a total luminous transmittance at a specific level or less, a density within a specific range, and a strain recovery rate (80° C., 24 hours, 50% compression) at a specific level or more.

The present invention has been made based on these findings.

Specifically, the present invention provides, in an embodiment, a resin foam having a thickness recovery rate (23° C., one minute, 50% compression) as defined below of 70% or more and a strain recovery rate (80° C., 24 hours, 50% compression) as defined below of 80% or more;

in which:

the thickness recovery rate (23° C., one minute, 50% compression) is specified as a value determined by compressing the resin foam at 23° C. by 50% of an initial thickness thereof, holding the resin foam in the compressed state at 23° C. for one minute, subsequently decompressing the resin foam, measuring a thickness of the resin foam one second after the decompression, and calculating, as the thickness recovery rate, a percentage of the measured thickness with respect to the initial thickness; and

the strain recovery rate (80° C., 24 hours, 50% compression) is specified as a value determined by compressing the resin foam at 23° C. by 50% of an initial thickness thereof, holding the resin foam in the compressed state at 80° C. for 24 hours, returning the resin foam to 23° C. while maintaining the resin foam in the compressed state, subsequently decompressing the resin foam, determining a compressed distance and a recovered distance, and calculating, as the strain recovery rate, a percentage of the recovered distance with respect to the compressed distance.

Such resin foam according to this embodiment is also generically referred to as a “resin foam according to the first embodiment.”

The resin foam preferably has a thickness of from 0.1 to 5 mm and an average cell diameter of from 10 to 200 μm.

The resin foam preferably has a variation in impact absorption rate as defined below of 5% or less, in which:

the impact absorption rate (%) is specified by an expression as follows:

Impact absorption rate (%)=(F0−F1)/F0×100

where:

F0 represents a value determined by preparing a laminate including a supporting plate and an acrylic plate, bringing a steel ball into collision with the acrylic plate side of the laminate, measuring an impact force received by the supporting plate, and defining the measured impact force as F0; and

F1 represents a value determined by preparing a 1-mm thick sheet-like specimen from the resin foam, preparing a laminate including a supporting plate and an acrylic plate, inserting the specimen into between the supporting plate and the acrylic plate in the laminate, bringing a steel ball into collision with the acrylic plate side of the laminate, measuring an impact force received by the supporting plate, and defining the measured impact force as F1; and

the variation in impact absorption rate is specified as an absolute value of a difference in impact absorption rate (%) between two specimens of the resin foam, where one specimen undergoes compression at 23° C. for 5 minutes by 50% of an initial thickness thereof and subsequent decompression; and the other specimen undergoes compression at 180° C. for 5 minutes by 50% of an initial thickness thereof and subsequent decompression.

The present invention further provides, in another embodiment, a resin foam having a variation in impact absorption rate as defined below of 5% or less; in which:

the impact absorption rate (%) is specified by an expression as follows:

Impact absorption rate (%)=(F0−F1)/F0×100

where:

F0 represents a value determined by preparing a laminate including a supporting plate and an acrylic plate, bringing a steel ball into collision with the acrylic plate side of the laminate, measuring an impact force received by the supporting plate, and defining the measured impact force as F0; and

F1 represents a value determined by preparing a 1-mm thick sheet-like specimen from the resin foam, preparing a laminate including a supporting plate and an acrylic plate, inserting the specimen into between the supporting plate and the acrylic plate in the laminate, bringing a steel ball into collision with the acrylic plate side of the laminate, measuring an impact force received by the supporting plate, and defining the measured impact force as F1; and

the variation in impact absorption rate is specified as an absolute value of a difference in impact absorption rate (%) between two specimens of the resin foam, where one specimen undergoes compression at 23° C. for 5 minutes by 50% of an initial thickness thereof and subsequent decompression; and the other specimen undergoes compression at 180° C. for 5 minutes by 50% of an initial thickness thereof and subsequent decompression.

Such resin foam according to this embodiment is also generically referred to as a “resin foam according to the second embodiment.”

The present invention provides, in yet another embodiment, a resin foam having a rate of dimensional change as defined below of 30% or less after left stand at an ambient temperature of 200° C. for one hour and having a rate of weight change as defined below of 15 percent by weight or less after left stand at an ambient temperature of 200° C. for one hour,

in which:

the rate of dimensional change is specified as a value determined by preparing a sheet-like specimen having a width of 100 mm, a length of 100 mm, and a thickness of from 0.5 to 2 mm from the resin foam, measuring rates of dimensional change in a crosswise direction, a longitudinal direction, and a thickness direction, respectively, and defining a highest rate of dimensional change among the rates of dimensional changes in these directions as the rate of dimensional change.

Such resin foam according to this embodiment is also generically referred to as a “resin foam according to the third embodiment.”

These resin foams preferably have a total luminous transmittance of 10% or less.

In addition, the present invention provides, in still another embodiment, a resin foam having a total luminous transmittance of 10% or less, a density of from 0.01 to 0.8 g/cm³, and a strain recovery rate (80° C., 24 hours, 50% compression) as defined below of 80% or more;

in which the strain recovery rate (80° C., 24 hours, 50% compression) is specified as a value determined by compressing the resin foam at 23° C. by 50% of an initial thickness thereof, holding the resin foam in the compressed state at 80° C. for 24 hours, returning the resin foam to 23° C. while maintaining the resin foam in the compressed state, decompressing the resin foam, measuring a recovered distance of the resin foam, determining a compressed distance and a recovered distance, and calculating, as the strain recovery rate, a percentage of the recovered distance with respect to the compressed distance.

Such resin foam according to this embodiment is also generically referred to as a “resin foam according to the fourth embodiment.”

### Advantageous Effects of Invention

The resin foam according to the first embodiment of the present invention has a thickness recovery rate (23° C., one minute, 50% compression) and a strain recovery rate (80° C., 24 hours, 50% compression) both at specific levels or more and thereby exhibits excellent dust-proofness even at high temperatures.

The resin foam according to the second embodiment of the present invention has a variation in impact absorption rate at a specific level or less and can thereby satisfactorily absorb impact even at high temperatures.

The resin foam according to the third embodiment of the present invention has a rate of dimensional change at a specific level or less after left stand at an ambient temperature of 200° C. for one hour, has a rate of weight change at a specific level or less after left stand at an ambient temperature of 200° C. for one hour, and is thereby highly resistant to heat.

In addition, the resin foam according to the fourth embodiment of the present invention has a total luminous transmittance at a specific level or less and a density within a specific range, has a strain recovery rate (80° C., 24 hours, 50% compression) at a specific level or more, is thereby highly resistant to heat, is satisfactorily flexible, and can effectively block light.

### BRIEF DESCRIPTION OF DRAWINGS

FIG. 1 depicts a schematic diagram illustrating a pendulum impact tester.

FIG. 2 depicts a schematic diagram of an evaluation sample for use in dynamic dust-proofness evaluation.

FIG. 3 depicts a schematic cross-sectional view of a dynamic dust-proofness evaluation chamber assembled with the evaluation sample.

FIG. 4 depicts a schematic cross-sectional view illustrating a tumbler in which the evaluation chamber is placed.

FIG. 5 depict a top view and a cut end view of the evaluation chamber assembled with the evaluation sample.

### DESCRIPTION OF EMBODIMENTS

Resin foams according to embodiments of the present invention are foams each including a resin. Of such resin foams according to the present invention, resin foams according to the first, second, third, and fourth embodiments will be illustrated below. As used herein the term “resin foams according to the first to fourth embodiments” refers to all the resin foams according to the first, second, third, and fourth embodiments.

The resin foam according to the first embodiment of the present invention is a resin foam having an after-defined thickness recovery rate (23° C., one minute, 50% compression) of 70% or more and an after-defined strain recovery rate (80° C., 24 hours, 50% compression) of 80% or more, in which:

the thickness recovery rate (23° C., one minute, 50% compression) is specified as a value determined by compressing the resin foam at 23° C. by 50% of an initial thickness thereof, holding the resin foam in the compressed state at 23° C. for one minute, subsequently decompressing the resin foam, measuring a thickness of the resin foam one second after the decompression, and calculating, as the thickness recovery rate, a percentage of the measured thickness with respect to the initial thickness; and

the strain recovery rate (80° C., 24 hours, 50% compression) is specified as a value determined by compressing the resin foam at 23° C. by 50% of an initial thickness thereof, holding the resin foam in the compressed state at 80° C. for 24 hours, returning the resin foam to 23° C. while maintaining the resin foam in the compressed state, subsequently decompressing the resin foam, determining a compressed distance and a recovered distance, and calculating, as the strain recovery rate, a percentage of the recovered distance with respect to the compressed distance.

The resin foam according to the first embodiment of the present invention has a thickness recovery rate (23° C., one minute, 50% compression) of 70% or more and preferably 80% or more. The resin foam according to the first embodiment of the present invention, as having a thickness recovery rate (23° C., one minute, 50% compression) of 70% or more, is highly recoverable instantaneously (instantaneously recoverable from a deformed state).

The resin foam according to the first embodiment of the present invention has a strain recovery rate (80° C., 24 hours, 50% compression) of 80% or more and preferably 85% or more. The resin foam according to the first embodiment of the present invention, as having a strain recovery rate (80° C., 24 hours, 50% compression) of 80% or more, exhibits satisfactory sealability and dust-proofness at high temperatures (e.g., from 60° C. to 200° C., and particularly from 60° C. to 120° C.)

The resin foam according to the first embodiment of the present invention, as having a thickness recovery rate (23° C., one minute, 50% compression) and a strain recovery rate (80° C., 24 hours, 50% compression) at specific levels or more, excels in dust-proofness, particularly in dynamic dust-proofness, not only at room temperature, but also at high temperatures.

The resin foam according to the first embodiment of the present invention may have an average cell diameter not critical, but preferably from 10 to 200 μm and more preferably from 10 to 150 μm. Control of the average cell diameter to be 200 μm or less in terms of upper limit allows the resin foam to exhibit better dust-proofness and good light-blocking effect. Control of the average cell diameter to be 10 μm or more in terms of lower limit allows the resin foam to be satisfactorily flexible. The average cell diameter may be determined typically by cutting the resin foam, capturing an image of a cross-sectional cell structure of the cut resin foam using a digital microscope, and analyzing the image.

The resin foam according to the first embodiment of the present invention, when having an average cell diameter of 200 μm or less, may have better dust-proofness, particularly better dynamic dust-proofness, even when having a small thickness (a thickness of typically from 0.1 to 5 mm, preferably from 0.1 to 2 mm, more preferably from 0.1 to 1 mm, and particularly preferably from 0.1 to 0.5 mm). Specifically, the resin foam according to the first embodiment of the present invention having a thickness recovery rate (23° C., one minute, 50% compression) of 70% or more and a strain recovery rate (80° C., 24 hours, 50% compression) of 80% or more, when having an average cell diameter of 200 μm or less, may exhibit excellent dust-proofness even when it is a thin layer.

The resin foam according to the first embodiment of the present invention, when having an average cell diameter of 200 μm or less and a thickness of 0.1 to 1 mm, is advantageously usable in applications where the resin foam should be a thin layer and be resistant to heat.

The resin foam according to the first embodiment of the present invention may have an after-defined variation in impact absorption rate not critical, but preferably 5% or less and more preferably 3% or less,

in which:

the impact absorption rate (%) is specified by an expression as follows:

Impact absorption rate (%)=(F0−F1)/F0×100

where:

F0 represents a value determined by preparing a laminate including a supporting plate and an acrylic plate, bringing a steel ball into collision with the acrylic plate side of the laminate, measuring an impact force received by the supporting plate, and defining the measured impact force as F0; and

F1 represents a value determined by preparing a 1-mm thick sheet-like specimen from the resin foam, preparing a laminate including a supporting plate and an acrylic plate, inserting the specimen into between the supporting plate and the acrylic plate in the laminate, bringing a steel ball into collision with the acrylic plate side of the laminate, measuring an impact force received by the supporting plate, and defining the measured impact force as F1; and

the variation in impact absorption rate is specified as an absolute value of a difference in impact absorption rate (%) between two specimens of the resin foam, where one specimen undergoes compression at 23° C. for 5 minutes by 50% of an initial thickness thereof and subsequent decompression; and the other specimen undergoes compression at 180° C. for 5 minutes by 50% of an initial thickness thereof and subsequent decompression.

The resin foam according to the first embodiment of the present invention, when having an above-defined variation in impact absorption rate of 5% or less, is highly thermally stable in impact absorptivity and is stably usable not only at room temperature, but also at high ambient temperatures (e.g., from 60° C. to 200° C.).

The resin foam according to the first embodiment of the present invention may have a total luminous transmittance not critical, but preferably 10% or less and more preferably 3% or less. The resin foam, when having a total luminous transmittance of 10% or less, is advantageously usable for applications requiring light blocking. The “total luminous transmittance” herein refers to a total luminous transmittance of a 0.6-mm thick sheet specimen prepared from the resin foam, as determined according to JIS K 7136.

The resin foam according to the second embodiment of the present invention is a resin foam having an above-defined variation in impact absorption rate of 5% or less.

The resin foam according to the second embodiment of the present invention has an above-defined variation in impact absorption rate of 5% or less and more preferably 3% or less. The resin foam according to the second embodiment of the present invention, as having a variation in impact absorption rate of 5% or less, is highly thermally stable in impact absorptivity and is stably usable not only at room temperature, but also at high ambient temperatures (e.g., from 60° C. to 200° C.).

The resin foam according to the second embodiment of the present invention may have a total luminous transmittance not critical, but preferably 10% or less and more preferably 5% or less. The resin foam, when having a total luminous transmittance of 10% or less, is advantageously usable in applications requiring light blocking. The total luminous transmittance may be determined by the procedure as above.

The resin foam according to the third embodiment of the present invention is a resin foam having an after-defined rate of dimensional change of 10% or less after left stand at an ambient temperature of 200° C. for one hour and having a rate of weight change of 15 percent by weight or less after left stand at an ambient temperature of 200° C. for one hour.

The resin foam according to the third embodiment of the present invention has a rate of dimensional change of 30% or less, preferably 10% or less, and more preferably 5% or less after left stand at 200° C. for one hour. The resin foam according to the third embodiment of the present invention, as having a rate of dimensional change of 10% or less, is highly thermally stable and is stably usable not only at room temperature, but also at high ambient temperatures (e.g., from 60° C. to 200° C.).

The “rate of dimensional change” refers to a value determined by preparing, from the resin foam, a sheet-like specimen having a width of 100 mm, a length of 100 mm, and a thickness of from 0.5 to 2 mm, measuring rates of dimensional change in a crosswise direction (crosswise direction), a longitudinal direction (machine direction), and a thickness direction, respectively, and defining a highest rate of dimensional change among the rates of dimensional change in these directions as the rate of dimensional change. Typically, when the rate of dimensional change is 10% or less, it means that all the rates of dimensional change in the crosswise direction, the machine direction, and the thickness direction are 10% or less. The rate of dimensional change (%) is determined according to an expression as follows:

Rate of dimensional change (%)=(L0−L1)/L0×100

where:

L0 represents the initial specimen's dimension (blank value); and

L1 represents the specimen's dimension after left stand at 200° C. for one hour.

The resin foam according to the third embodiment of the present invention has a rate of weight change of 15 percent by weight or less, and preferably 5 percent by weight or less, after left stand at 200° C. for one hour. The resin foam according to the third embodiment of the present invention, as having a rate of weight change of 15 percent by weight or less, is highly thermally stable and stably usable not only at room temperature, but also at high ambient temperatures (e.g., from 60° C. to 200° C.).

The rate of weight change (%) is determined according to an expression as follows:

Rate of weight change (%)=(W0−W1)/W0×100

where:

W0 represents the initial specimen's weight (blank value); and

W1 represents the specimen's weight after left stand at 200° C. for one hour.

The resin foam according to the third embodiment of the present invention may have a total luminous transmittance not critical, but preferably 10% or less and more preferably 3% or less. The resin foam, when having a total luminous transmittance of 10% or less, is advantageously usable in applications requiring light blocking. The total luminous transmittance may be determined by the procedure as above.

The resin foam according to the third embodiment of the present invention is highly resistant to heat because of having a rate of dimensional change of 30% or less (preferably 10% or less, and more preferably 5% or less) after left stand at an ambient temperature of 200° C. for one hour and having a rate of weight change of 15 percent by weight or less after left stand at an ambient temperature of 200° C. for one hour.

The resin foam according to the fourth embodiment of the present invention is a resin foam having a total luminous transmittance of 10% or less, a density of from 0.01 to 0.8 g/cm³, and an above-defined strain recovery rate (80° C., 24 hours, 50% compression) of 80% or more.

The resin foam according to the fourth embodiment of the present invention has a total luminous transmittance of 10% or less and preferably 3% or less. The resin foam according to the fourth embodiment of the present invention is therefore advantageously usable in applications requiring light blocking. The total luminous transmittance may be determined by the procedure as above.

The resin foam according to the fourth embodiment of the present invention has a density (apparent density) of from 0.01 to 0.8 g/cm³, and preferably from 0.02 to 0.2 g/cm³. Because of having a density within this range, the resin foam according to the fourth embodiment of the present invention has appropriate strengths and flexibility in good balance and readily develops satisfactory impact absorption and satisfactory recoverability (recoverability from a deformed state).

The resin foam according to the fourth embodiment of the present invention has a strain recovery rate (80° C., 24 hours, 50% compression) of 80% or more, and preferably 85% or more. The resin foam according to the third embodiment of the present invention, as having a strain recovery rate (80° C., 24 hours, 50% compression) of 80% or more, exhibits excellent sealability and dust-proofness at high temperatures (e.g., from 60° C. to 200° C., particularly from 60° C. to 120° C.)

The resin foam according to the fourth embodiment of the present invention has a total luminous transmittance of 10% or less, a density of from 0.01 to 0.8 g/cm³, and a strain recovery rate (80° C., 24 hours, 50% compression) of 80% or more. The resin foam is thereby highly resistant to heat, is satisfactorily flexible, and effectively blocks light.

The resin foams according to the first to fourth embodiments of the present invention are not critical in thickness and shape that are suitably selected according to the intended use. In a preferred embodiment, the resin foams are in the form of a sheet, tape, or film. The resin foams may each have a thickness not critical, but preferably from 0.1 to 20 mm, more preferably from 0.1 to 15 mm, and furthermore preferably from 0.1 to 5 mm. The resin foams may be subjected to a processing such as blanking or punching to have a desired thickness and a desired shape.

The resin foams according to the first to fourth embodiments of the present invention may each have a cell structure (cellular structure) not limited, but preferably have a closed cell structure or semi-open semi-closed cell structure. As used herein the term “semi-open semi-closed (cell) structure” refers to a cell structure including both a closed cell structure and an open cell structure in coexistence. The semi-open semi-closed structure may include the closed cell structure in a content not critical. Particularly, the resin foams have a cell structure including a closed cell structure moiety of preferably 80% or more, and more preferably 90% or more.

The resin foams according to the second, third, and fourth embodiments of the present invention may have an average cell diameter of the cell structure (cellular structure) not critical, but preferably from 10 to 200 μm and more preferably from 10 to 150 μm. The resin foams, when being controlled to have an average cell diameter of 200 μm or less in terms of upper limit, may have better dust-proofness and can block light satisfactorily effectively. The resin foams, when being controlled to have an average cell diameter of 10 μm or more in terms of lower limit, may be satisfactorily flexible.

The cell structure and the average cell diameter may be determined typically by cutting a sample resin foam, capturing an image of a cross-sectional cell structure of the cut resin foam using a digital microscope, and analyzing the image.

The resin foams according to the first, second, and third embodiments of the present invention may have a density (apparent density) not critical, but preferably from 0.01 to 0.8 g/cm³ and more preferably from 0.02 to 0.2 g/cm³. The resin foams, when having a density within this range, can have appropriate strengths and flexibility and readily develop cushioning properties and recoverability (recoverability from a deformed state) both at satisfactory levels.

The resin foams according to the first to fourth embodiments of the present invention may have a compression load upon 50% compression of not critical, but preferably from 0.1 to 5.0 N/cm², more preferably from 0.1 to 3.0 N/cm², and furthermore preferably from 0.1 to 2.0 N/cm², in terms of dust-proofness and flexibility. As used herein the term “compression load upon 50% compression” refers to a load necessary for the resin foam to be compressed by 50% of the initial thickness. The compression load upon 50% compression may be determined by the compressive hardness measuring method described in JIS K 6767.

The resin foams according to the third and fourth embodiments of the present invention have an above-defined variation in impact absorption rate of preferably 5% or less and more preferably 3% or less. The resin foams, when having a variation in impact absorption rate of 5% or less, are highly thermally stable in impact absorptivity and are stably usable not only at room temperature, but also at high ambient temperatures (e.g., from 60° C. to 200° C.).

The resin foams according to the first, second, and fourth embodiments of the present invention may have a rate of dimensional change (above-defined rate of dimensional change) not critical, but preferably 30% or less, more preferably 10% or less, and furthermore preferably 5% or less, after left stand at 200° C. for one hour. The resin foams, when having the rate of dimensional change of 30% or less (particularly 10% or less), are highly thermally stable and are stably usable not only at room temperature, but also at high ambient temperatures (e.g., from 60° C. to 200° C.).

The resin foams according to the first, second, and fourth embodiments of the present invention may have a rate of weight change (above-defined rate of weight change), but preferably 15% or less and more preferably 5% or less, after left stand at 200° C. for one hour not critical. The resin foams, when having the rate of weight change of 15% or less, are highly thermally stable and are stably usable not only at room temperature, but also at high ambient temperatures (e.g., from 60° C. to 200° C.).

The resin foams according to the first to fourth embodiments of the present invention may have a degree of blackness L* not critical, but preferably less than 50, more preferably less than 45, furthermore preferably less than 40. The “degree of blackness L*” is one of characteristics of a color and refers to a degree of lightness of the color. With an increasing degree of blackness L*, the color has increasing lightness. The color is white when L* is 100; and the color is black when L* is 0. With an increasing degree of blackness, the resin foams have a lower total luminous transmittance and exhibit better blocking effects.

The resin foams according to the first to fourth embodiments of the present invention may be formed from a resin composition and are preferably formed by subjecting a resin composition to expansion molding. The “resin composition” refers to a composition that contains at least a resin and is used for the formation of the resin foams according to the first to fourth embodiments of the present invention.

The resin composition is not limited, but is preferably a “resin composition containing at least an acrylic polymer, an active-energy-ray-curable compound having two (meth)acryloyl groups per molecule, an active-energy-ray-curable compound having three or more (meth)acryloyl groups per molecule, and a thermal crosslinking agent.” The “resin composition containing at least an acrylic polymer, an active-energy-ray-curable compound having two (meth)acryloyl groups per molecule, an active-energy-ray-curable compound having three or more (meth)acryloyl groups per molecule, and a thermal crosslinking agent” is herein also referred to as a “resin composition of the present invention.” An “active-energy-ray-curable compound having “n” (meth)acryloyl groups (in the number of “n”) per molecule” is herein also referred to as a “n-functional (meth)acrylate.” Typically, an “active-energy-ray-curable compound having two (meth)acryloyl groups per molecule” is also referred to as a “bifunctional (meth)acrylate,” and an “active-energy-ray-curable compound having three or more (meth)acryloyl groups per molecule” is also referred to as a “trifunctional or higher (meth)acrylate.” As used herein the term “(meth)acryl(ic)” refers to “acryl(ic) and/or methacryl(ic),” and the same is true for other descriptions. Also as used herein the term “(meth)acrylate” refers to “acrylate and/or methacrylate,” and the same is also true for other descriptions.

The resin composition of the present invention contains active-energy-ray-curable compounds (a bifunctional (meth)acrylate and a trifunctional or higher (meth)acrylate) and a thermal crosslinking agent. This helps the resin foams to exhibit better shape retention and to become resistant to deformation and contraction with time, when the resin composition of the present invention is subjected to expansion molding and subsequently subjected to active energy ray irradiation to form a crosslinked structure by the action of the bifunctional (meth)acrylate and trifunctional or higher (meth)acrylate, and/or subjected to a heating treatment to form a crosslinked structure by the action of the thermal crosslinking agent. This allows the resin foams to maintain a cell structure with a high expansion ratio, to require a smaller compression load, and to be more flexible.

The resin composition of the present invention contains a thermal crosslinking agent. This induces crosslinking of the acrylic polymer moiety and helps the resin foams to be more resistant to heat and to be more durable, when the resin composition of the present invention is subjected to expansion molding and then subjected to a heating treatment to form a crosslinked structure by the action of the thermal crosslinking agent.

In addition, the resin composition of the present invention employs, as active-energy-ray-curable compounds, a bifunctional (meth)acrylate and a trifunctional or higher (meth)acrylate in combination. The resin composition, as employing a bifunctional (meth)acrylate, helps the resin constituting the resin foams according to the present invention to have a lower Tg. This allows the resin foams to be resistant to fixation of a deformed state when they are deformed due to an external load. The resin composition, as employing a trifunctional (meth)acrylate, helps the resin foams to be more resistant to heat. This enables the resin foams to have strain recoverability at high temperatures and heat resistance both at satisfactory levels. A resin composition employing a bifunctional (meth)acrylate alone as the active-energy-ray-curable compound may fail to impart sufficient heat resistance to the resin foams.

The resin composition of the present invention employs, as active-energy-ray-curable compounds, a bifunctional (meth)acrylate and a trifunctional or higher (meth)acrylate in combination. The combination use of the trifunctional or higher (meth)acrylate allows the formation of a three-dimensional crosslinked structure and helps the resin foams to exhibit better recoverability from deformation. This also helps the resin foams to exhibit superior instantaneous recoverability. As used herein the term “recoverability” refers to a property by which a resin foam, when deformed due to an external load, attempts to return to a state before deformation.

The resin composition of the present invention contains at least an acrylic polymer, an active-energy-ray-curable compound having two (meth)acryloyl groups per molecule, an active-energy-ray-curable compound having three or more (meth)acryloyl groups per molecule, and a thermal crosslinking agent. The resin composition of the present invention may be a composition containing a thermoplastic resin. The resin composition of the present invention may contain the components (acrylic polymers, active-energy-ray-curable compounds having two (meth)acryloyl groups per molecule, active-energy-ray-curable compounds having three or more (meth)acryloyl groups per molecule, and thermal crosslinking agents) alone or in combination in each category.

The acrylic polymer acts as an essential component in the resin composition of the present invention and is a polymer constituting the resin foams. The acrylic polymer is preferably a homopolymer or copolymer using an acrylic alkyl ester having an alkyl group (straight chain, branched chain, or cyclic alkyl group) as an essential monomer component. The acrylic polymer preferably has rubber elasticity at room temperature. The resin composition of the present invention may contain each of different acrylic polymers alone or in combination. The “acrylic alkyl ester having an alkyl group” is herein also simply referred to as an “acrylic alkyl ester.”

The resin composition of the present invention may contain the acrylic polymer(s) in a content not critical, but preferably 20 percent by weight or more (e.g., from 20 to 80 percent by weight) and more preferably 30 percent by weight or more (e.g., from 30 to 70 percent by weight) based on the total amount (100 percent by weight) of the resin composition of the present invention.

The acrylic alkyl ester is preferably exemplified by, but not limited to, ethyl acrylate (EA), butyl acrylate (BA), 2-ethylhexyl acrylate (2-EHA), isooctyl acrylate, isononyl acrylate, propyl acrylate, isobutyl acrylate, hexyl acrylate, and isobornyl acrylate (IBXA). Each of different acrylic alkyl esters may be used alone or in combination.

Monomer components to constitute the acrylic polymer may include the acrylic alkyl ester(s) in a content not critical, but preferably 50 percent by weight or more and more preferably 70 percent by weight or more, based on the total amount (100 percent by weight) of the entire monomer components.

When the acrylic polymer is a copolymer, monomer components to constitute the acrylic polymer further employ one or more copolymerizable monomer components in addition to the acrylic alkyl ester(s). The “copolymerizable monomer component(s)” is herein also referred to as “additional monomer component(s).” Each of different additional monomer components may be used alone or in combination.

The additional monomer component is preferably a monomer that provides a functional group in the acrylic polymer, which functional group is reactive with a functional group of the after-mentioned thermal crosslinking agent. Specifically, the additional monomer component is preferably a monomer that provides in the acrylic polymer a crosslinking point for crosslinking by the action of the thermal crosslinking agent. Such functional group of the acrylic polymer, which functional group is reactive with a functional group of the thermal crosslinking agent, is herein also referred to as a “reactive functional group.” Of the additional monomer components, a monomer that provides in the acrylic polymer a functional group serving as a crosslinking point for the thermal crosslinking agent, in other words, a monomer that provides a reactive functional group in the acrylic polymer is also referred to as a “functional-group-containing monomer.”

In short, the acrylic polymer is preferably a copolymer between the acrylic alkyl ester and the functional-group-containing monomer. The functional-group-containing monomer is exemplified by carboxyl-containing monomers such as methacrylic acid (MAA), acrylic acid (AA), and itaconic acid (IA); hydroxyl-containing monomers such as hydroxyethyl methacrylate (HEMA), 4-hydroxybutyl acrylate (4HBA), and hydroxypropyl methacrylate (HAMA); amino-containing monomers such as dimethylaminoethyl methacrylate (DM); amido-containing monomers such as acrylamide (AM) and methylolacrylamide (N-MAN); epoxy-containing monomers such as glycidyl methacrylate (GMA); acid-anhydride-containing monomers such as maleic anhydride; and cyano-containing monomers such as acrylonitrile (AN). Among them, preferred for easy crosslinking are carboxyl-containing monomers, hydroxyl-containing monomers, and cyano-containing monomers; of which acrylic acid (AA), 4-hydroxybutyl acrylate (4HBA), and acrylonitrile (AN) are particularly preferred. Each of different functional-group-containing monomers may be used alone or in combination.

Monomer components to constitute the acrylic polymer may contain the functional-group-containing monomer(s) in a content not critical, but preferably from 2 to 40 percent by weight, more preferably from 2 to 30 percent by weight, and furthermore preferably from 5 to 20 percent by weight, based on the total amount (100 percent by weight) of the entire monomer components. This range is preferred for preventing the resin foams from becoming hard and being less flexible due to excessive crosslinking, while maintaining the crosslinking density at a sufficient level.

Exemplary additional monomer components other than the functional-group-containing monomers include vinyl acetate (VAc), styrene (St), methyl methacrylate (MMA), methyl acrylate (MA), and methoxyethyl acrylate (MEA). Among them, methoxyethyl acrylate (MEA) is preferred in terms of cold resistance.

The active-energy-ray-curable compound having two (meth)acryloyl groups per molecule (bifunctional (meth)acrylate) is exemplified by, but not limited to, polyethylene glycol di(meth)acrylate, polypropylene glycol di(meth)acrylate, 1,4-butanediol di(meth)acrylate, tetraethylene glycol di(meth)acrylate, 1,6-hexanediol di(meth)acrylate, neopentyl glycol di(meth)acrylate, bisphenol-F-EO-modified di(meth)acrylate, bisphenol-A-EO-modified di(meth)acrylate, and isocyanuric acid-EO-modified di(meth)acrylate. Such bifunctional (meth)acrylates may each be a monomer or oligomer. Each of different bifunctional (meth)acrylates may be used alone or in combination.

The active-energy-ray-curable compound having three or more (meth)acryloyl groups per molecule (trifunctional or higher (meth)acrylate) is exemplified by trimethylolpropane tri(meth)acrylate, pentaerythritol tri(meth)acrylate, tetramethylolmethane tetra(meth)acrylate, pentaerythritol tetra(meth)acrylate, multifunctional polyester acrylates, urethane (meth)acrylates, multifunctional urethane acrylates, epoxy (meth)acrylates, and oligoester (meth)acrylates. Of such trifunctional or higher (meth)acrylates, preferred are trifunctional (meth)acrylates such as trimethylolpropane tri(meth)acrylate and pentaerythritol tri(meth)acrylate. They are preferred for imparting a high elastic modulus to the resin foams so as to impede contraction of them. The trifunctional or higher (meth)acrylates may each be a monomer or oligomer. Each of different trifunctional or higher (meth)acrylates may be used alone or in combination.

The resin composition of the present invention may contain the bifunctional (meth)acrylate(s) and the trifunctional or higher (meth)acrylate(s) in a total content not critical, but preferably from 20 to 150 parts by weight, more preferably from 30 to 120 parts by weight, and furthermore preferably from 40 to 100 parts by weight, per 100 parts by weight of the acrylic polymer. The resin composition, if containing the two components in a total content of less than 20 parts by weight, may fail to help the resin foams to be resistant to deformation and contraction of the cell structure with time and to maintain a high expansion ratio. The resin composition, if containing the two components in a total content of more than 150 parts by weight, may cause the resin foams to be hard and less flexible.

The ratio (by weight) of the bifunctional (meth)acrylate(s) to the trifunctional or higher (meth)acrylate(s) in the resin composition of the present invention is not critical, but is preferably from 20:80 to 80:20 and more preferably from 30:70 to 70:30. This range is preferred in terms of balance between heat resistance and strain recoverability at high temperatures.

The thermal crosslinking agent is exemplified by, but not limited to, isocyanate crosslinking agents, epoxy crosslinking agents, melamine crosslinking agents, peroxide crosslinking agents, urea crosslinking agents, metal alkoxide crosslinking agents, metal chelate crosslinking agents, metal salt crosslinking agents, carbodiimide crosslinking agents, oxazoline crosslinking agents, aziridine crosslinking agents, and amine crosslinking agents. Each of different crosslinking agents may be used alone or in combination.

Of such thermal crosslinking agents, preferred for better heat resistance of the resin foams are isocyanate crosslinking agents and amine crosslinking agents.

The isocyanate crosslinking agents (multifunctional isocyanate compounds) are exemplified by lower aliphatic polyisocyanates such as 1,2-ethylene diisocyanate, 1,4-butylene diisocyanate, and 1,6-hexamethylene diisocyanate; alicyclic polyisocyanates such as cyclopentylene diisocyanates, cyclohexylene diisocyanates, isophorone diisocyanates, hydrogenated tolylene diisocyanates, and hydrogenated xylene diisocyanates; and aromatic polyisocyanates such as 2,4-tolylene diisocyanate, 2,6-tolylene diisocyanate, 4,4′-diphenylmethane diisocyanate, and xylylene diisocyanates. The isocyanate crosslinking agents are also exemplified by commercial products such as a trimethylolpropane adduct of tolylene diisocyanate [available from Nippon Polyurethane Industry Co., Ltd. under the trade name of “CORONATE L”], a trimethylolpropane adduct of hexamethylene diisocyanate [available from Nippon Polyurethane Industry Co., Ltd. under the trade name of “CORONATE HL”], and a trimethylolpropane adduct of xylylene diisocyanate [available from Mitsui Chemicals Inc. under the trade name of “TAKENATE D110N”].

The amine crosslinking agents are exemplified by hexamethylenediamine, triethylenetetramine, tetraethylenepentamine, hexamethylenediamine carbamate, N,N′-dicinnamylidene-1,6-hexanediamine, 4,4′-methylenebis(cyclohexylamine) carbamate, and 4,4′-(2-chloroaniline).

The resin composition of the present invention may contain the thermal crosslinking agent(s) in a content not critical, but preferably from 0.01 to 10 parts by weight and more preferably from 0.05 to 5 parts by weight, per 100 parts by weight of the acrylic polymer. The resin composition, if containing the thermal crosslinking agent(s) in a content of less than 0.01 part by weight, may cause the resin foams to fail to sufficiently enjoy the effects of the thermal crosslinking agent. In contrast, the resin composition, if containing the thermal crosslinking agent(s) in a content of more than 10 parts by weight, may cause a crosslinking reaction to occur excessively and thereby cause the resin foams to be hard and less flexible.

In a preferred embodiment, the resin composition of the present invention further contains a radical scavenger. As used herein the term “radical scavenger” refers to a compound that can trap a free radical causing a radical polymerization reaction. The resin composition of the present invention, when containing a radical scavenger, may help the resin foams to exhibit better working stability upon molding. While remaining unclear, this is probably because as follows. When the resin composition of the present invention is subjected to molding under some conditions, a reaction of active-energy-ray-curable compounds contained as essential components may be accelerated. This is probably because free radicals derived from the acrylic polymer accelerate the curing of the active-energy-ray-curable compounds, which free radicals are formed by mechanical or thermal cleavage of the molecular chain of the acrylic polymer. The radical scavenger, when contained in the resin composition of the present invention, can suppress such molecular chain cleavage and can trap free radicals.

When an after-mentioned inert gas, such as nitrogen or carbon dioxide, is used as a blowing agent in expansion molding of the resin composition of the present invention, there is no inhibitory factor on the radical polymerization reaction, and free radicals once formed resist inactivation. Also to prevent this, the radical scavenger is preferably contained in the resin composition. The radical scavenger also acts as a thermal stabilizer by trapping free radicals in the resin composition of the present invention.

The radical scavenger is exemplified by, but not limited to, antioxidants and age inhibitors. Each of different radical scavengers may be used alone or in combination.

The antioxidants are exemplified by phenolic antioxidants such as hindered phenolic antioxidants; and amine antioxidants such as hindered amine antioxidants. The hindered phenolic antioxidants are exemplified by pentaerythritol tetrakis[3-(3,5-di-tert-butyl-4-hydroxyphenyl)propionate] (available under the trade name of “Irganox 1010” from BASF Japan Ltd.), octadecyl 3-(3,5-di-tert-butyl-4-hydroxyphenyl)propionate (available under the trade name of “Irganox 1076” from BASF Japan Ltd.), 4,6-bis(dodecylthiomethyl)-o-cresol (available under the trade name of “Irganox 1726” from BASF Japan Ltd.), triethylene glycol bis[3-(3-tert-butyl-5-methyl-4-hydroxyphenyl)propionate] (available under the trade name of “Irganox 245” from BASF Japan Ltd.), bis(2,2,6,6-tetramethyl-4-piperidyl)sebacate (available under the trade name of “TINUVIN 770” from BASF Japan Ltd.), and a polycondensate between dimethyl succinate and 4-hydroxy-2,2,6,6-tetramethyl-1-piperidineethanol (dimethyl succinate-1-(2-hydroxyethyl)-4-hydroxy-2,2,6,6-tetramethylpiperidine polycondensate) (available under the trade name of “TINUVIN 622” from BASF Japan Ltd.). The hindered amine antioxidants are exemplified by bis(1,2,2,6,6-pentamethyl-4-piperidyl)sebacate (methyl) (available under the trade name of “TINUVIN 765” from BASF Japan Ltd.) and bis(1,2,2,6,6-pentamethyl-4-piperidyl)[[3,5-bis(1,1-dimethylethyl)-4-hydroxyphenyl]methyl]butylmalonate (available under the trade name of “TINUVIN 765” from BASF Japan Ltd.).

The age inhibitors are exemplified by phenolic age inhibitors and amine age inhibitors. The phenolic age inhibitors are exemplified by 2-tert-butyl-6-(3-tert-butyl-2-hydroxy-5-methylbenzyl)-4-methylphenyl acrylate (available under the trade name of “SUMILIZER GM” from Sumitomo Chemical Co., Ltd.) and 2-[1-(2-hydroxy-3,5-di-tert-pentylphenyl)ethyl]-4,6-di-tert-pentylphenyl acrylate (available under the trade name of “SUMILIZER GS(F)” from Sumitomo Chemical Co., Ltd.). The amine age inhibitors are exemplified by 4,4′-bis(α,α-dimethylbenzyl)diphenylamine (available under the trade name of “Noclac CD” from Ouchi Shinko Chemical Industrial Co., Ltd.; and under the trade name of “Naugard 445” from Crompton Corporation), N,N′-diphenyl-p-phenylenediamine (available under the trade name of “Noclac DP” from Ouchi Shinko Chemical Industrial Co., Ltd.), and p-(p-toluenesulfonylamido)diphenylamine (available under the trade name of “Noclac TD” from Ouchi Shinko Chemical Industrial Co., Ltd.).

Of such radical scavengers, preferably used is at least one selected from the group consisting of phenolic antioxidants, phenolic age inhibitors, amine antioxidants, and amine age inhibitors. These are preferred in terms of working stability during molding and curability upon active energy ray irradiation. Among them, the phenolic age inhibitors are more preferred.

The resin composition of the present invention may contain the radical scavenger(s) in a content not critical, but preferably from 0.05 to 10 parts by weight and more preferably from 0.1 to 10 parts by weight, per 100 parts by weight of the acrylic polymer. The radical scavenger(s), if contained in a content of less than 0.05 part by weight, may fail to sufficiently trap radicals formed upon molding. In contrast, the radical scavenger(s), if contained in a content of more than 10 parts by weight, may disadvantageously cause inferior foaming upon expansion molding of the resin composition and/or disadvantageously bleed out to the produced resin foam surface.

In another preferred embodiment, the resin composition of the present invention further contains a photoinitiator. This is because such a photoinitiator, when contained in the resin composition, helps the bifunctional (meth)acrylate and the trifunctional or higher (meth)acrylate to more easily react to form a crosslinked structure.

The photoinitiator is exemplified by, but not limited to, benzoin ether photoinitiators such as benzoin methyl ether, benzoin ethyl ether, benzoin propyl ether, benzoin isopropyl ether, benzoin isobutyl ether, 2,2-dimethoxy-1,2-diphenylethan-1-one, and anisole methyl ether; acetophenone photoinitiators such as 2,2-diethoxyacetophenone, 2,2-dimethoxy-2-phenylacetophenone, 1-hydroxycyclohexyl phenyl ketone, 4-phenoxydichloroacetophenone, and 4-t-butyl-dichloroacetophenone; α-ketol photoinitiators such as 2-methyl-2-hydroxypropiophenone and 1-[4-(2-hydroxyethyl)-phenyl]-2-hydroxy-2-methylpropan-1-one; aromatic sulfonyl chloride photoinitiators such as 2-naphthalenesulfonyl chloride; photoactive oxime photoinitiators such as 1-phenyl-1,1-propanedione-2-(o-ethoxycarbonyl)-oxime; benzoin photoinitiators such as benzoin; benzil photoinitiators such as benzil; benzophenone photoinitiators such as benzophenone, benzoylbenzoic acid, 3,3′-dimethyl-4-methoxybenzophenone, polyvinylbenzophenone, and α-hydroxycyclohexyl phenyl ketone; ketal photoinitiators such as benzyl dimethyl ketal; thioxanthone photoinitiators such as thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone, and dodecylthioxanthone; α-amino ketone photoinitiators such as 2-methyl-1-[4-(methylthio)phenyl]-2-morpholinopropan-1-one and 2-benzyl-2-dimethylamino-1-(4-morpholinophenyl)-butanone-1; and acylphosphine oxide photoinitiators such as (2,4,6-trimethylbenzoyl)diphenylphosphine oxide and bis(2,4,6-trimethylbenzoyl)-phenylphosphine oxide. Each of different photoinitiators may be used alone or in combination.

The resin composition of the present invention may contain the photoinitiator(s) in a content not critical, but preferably from 0.01 to 5 parts by weight and more preferably from 0.2 to 4 parts by weight, per 100 parts by weight of the acrylic polymer.

In still another preferred embodiment, the resin composition of the present invention further contains powder particles. The powder particles function as a foam-nucleating agent upon expansion molding and, when contained in the resin composition of the present invention, may easily give a resin foam in a satisfactory expansion state.

The powder particles usable herein are exemplified by, but not limited to, powdery talc, silica, alumina, zeolite, calcium carbonate, magnesium carbonate, barium sulfate, zinc oxide, titanium oxide, aluminum hydroxide, magnesium hydroxide, mica, montmorillonite and other clay, carbon particles, glass fibers, and carbon tubes. Each of different types of powder particles may be used alone or in combination.

Though not critical, the powder particles preferably have an average particle diameter (particle size) of from 0.1 to 20 μm. The powder particles, if having an average particle diameter of less than 0.1 μm, may fail to sufficiently function as a nucleating agent; whereas the powder particles, if having an average particle diameter of more than 20 μm, may cause gas migration (outgassing) upon expansion molding.

The resin composition of the present invention may contain the powder particles in a content not critical, but preferably from 5 to 150 parts by weight and more preferably from 10 to 120 parts by weight, per 100 parts by weight of the acrylic polymer. The resin composition, if containing the powder particles in a content of less than 5 parts by weight, may fail to give a resin foam having a uniform cell structure. In contrast, the resin composition, if containing the powder particles in a content of more than 150 parts by weight, may have a remarkably high viscosity and may cause gas migration (outgassing) upon expansion molding, thus resulting in inferior expansion properties.

In yet another preferred embodiment, the resin composition of the present invention further contains a flame retardant. Because of containing a resin, the resin foams according to the present invention are characteristically flammable. For this reason, the resin composition preferably employs a flame retardant when the resin foams are used in applications essentially requiring impartment of flame retardancy, such as in electric/electronic appliance applications.

The flame retardant is preferably exemplified by, but not limited to, inorganic flame retardants such as flame-retardant powder particles.

The inorganic flame retardants are exemplified by bromine flame retardants, chlorine flame retardants, phosphorus flame retardants, and antimony flame retardants. However, chlorine flame retardants and bromine flame retardants might evolve a gas component upon combustion, which gas component is harmful to the human body and is corrosive to appliances; whereas phosphorus flame retardants and antimony flame retardants are disadvantageously harmful and/or explosive. To prevent these disadvantages, non-halogen non-antimony inorganic flame retardants are preferred among the inorganic flame retardants. The non-halogen non-antimony inorganic flame retardants are exemplified by hydrated metallic compounds such as aluminum hydroxide, magnesium hydroxide, hydrates of magnesium oxide-nickel oxide, and hydrates of magnesium oxide-zinc oxide. The hydrated metal oxides may undergo a surface treatment. Each of different flame retardants may be used alone or in combination.

The resin composition of the present invention may contain the flame retardant(s) in a content not critical, but preferably from 10 to 120 parts by weight per 100 parts by weight of the acrylic polymer. This range is preferred for obtaining a highly expanded foam while enjoying flame retarding effects.

Where necessary, the resin composition of the present invention may further contain various additives as follows. The additives are exemplified by crystal nucleators, plasticizers, lubricants, colorants (e.g., pigments and dyestuffs), ultraviolet absorbers, fillers, reinforcers, antistatic agents, surfactants, tension modifiers, shrinkage inhibitors, flowability improvers, vulcanizers, coupling agents (surface-treatment agents), and crosslinking coagents.

The resin composition of the present invention may be prepared by mixing and kneading the acrylic polymer, the bifunctional (meth)acrylate, the trifunctional or higher (meth)acrylate, the thermal crosslinking agent, and additional components optionally added, such as a radical scavenger. The mixing and kneading may be performed with heating.

As has been described above, the resin foams according to the first to fourth embodiments of the present invention are preferably formed from the resin composition of the present invention, and are more preferably formed by subjecting the resin composition of the present invention to expansion molding. In particular, the resin foams according to the first to fourth embodiments of the present invention are furthermore preferably formed by subjecting the resin composition of the present invention to expansion molding to give a foamed article and irradiating the foamed article with an active energy ray; and are still more preferably formed by subjecting the resin composition of the present invention to expansion molding to give a foamed article, irradiating the foamed article with an active energy ray, and further heating the resulting article. Specifically, the resin foams according to the first to fourth embodiments of the present invention are preferably formed by a production process including the steps of subjecting the resin composition of the present invention to expansion molding to give a foamed article; and irradiating the foamed article with an active energy ray to give a resin foam.

In other words, the resin foams according to the first to fourth embodiments of the present invention are preferably obtained by subjecting the resin composition of the present invention to expansion molding to form a foamed structure; and irradiating the foamed structure with an active energy ray to form a crosslinked structure by the action of the bifunctional (meth)acrylate and the trifunctional or higher (meth)acrylate. In particular, the resin foams according to the first to fourth embodiments of the present invention are more preferably obtained by subjecting the resin composition of the present invention to expansion molding to form a foamed structure; irradiating the foamed structure with an active energy ray to form a crosslinked structure by the action of the bifunctional (meth)acrylate and the trifunctional or higher (meth)acrylate; and further heating the resulting article to form a crosslinked structure by the action of the thermal crosslinking agent. As used herein the term “foamed structure” refers to a foam which is obtained by expansion molding of the resin composition of the present invention, but which has not yet undergone crosslinked structure formation.

The blowing agent for use in expansion molding of the resin composition of the present invention is not limited, but is preferably exemplified by one that is gaseous at room temperature and normal atmospheric pressure and is inert to the resin composition of the present invention, and with which the resin composition is impregnatable. Herein “one that is gaseous at room temperature and normal atmospheric pressure and is inert to the resin composition of the present invention, and with which the resin composition is impregnatable” is also referred to as an “inert gas.”

The inert gas is exemplified by rare gases (e.g., helium and argon), carbon dioxide, nitrogen, and air. Among them, preferred is carbon dioxide or nitrogen because the resin composition of the present invention can be impregnated therewith in a satisfactory amount at a satisfactory rate (speed). The inert gas may be a gaseous mixture.

When the inert gas is used as a blowing agent in expansion molding of the resin composition of the present invention, the resin composition preferably contains the radical scavenger, as described above. This is because as follows. Free radicals may be formed due to heat or mechanical shearing upon expansion molding of the resin composition. When the inert gas is used, inhibition on the radical polymerization reaction by oxygen does not occur, and the free radicals, once formed, resist inactivation. The formed free radicals might cause specific curing reactions of active-energy-ray-curable compounds such as the bifunctional (meth)acrylate and the trifunctional or higher (meth)acrylate and, to prevent this, should be trapped.

To speed up the impregnation rate of the resin composition of the present invention with the inert gas, the inert gas is preferably one in a high pressure state (of which carbon dioxide gas or nitrogen gas in a high pressure state is more preferred) and is more preferably one in a supercritical state (of which carbon dioxide gas or nitrogen gas in a supercritical state is more preferred). Such gas in a supercritical state becomes more soluble in the polymer and can be incorporated into the polymer in a higher concentration. Because of its high concentration upon impregnation as mentioned above, the supercritical gas generates a larger number of cell nuclei upon an abrupt pressure drop (decompression) after impregnation. The cell nuclei grow to form micro cells, which are present in a higher density than in a foam having the same porosity but produced with a gas in another state. Carbon dioxide has a critical temperature and a critical pressure of 31° C. and 7.4 MPa, respectively. Such inert gas in a high-pressure state is herein also referred to as a “high-pressure gas.”

Expansion molding of the resin composition of the present invention, namely, formation of a foamed structure by subjecting the resin composition to expansion molding, may employ a batch system or a continuous system. In the batch system, the resin composition of the present invention is previously molded into a suitable shape such as a sheet shape to give an unfoamed resin molded article (unfoamed molded article), the unfoamed resin molded article is impregnated with the high-pressure or supercritical inert gas as a blowing agent and subsequently decompressed to expand the article. In the continuous system, the resin composition of the present invention is kneaded with the inert gas as a blowing agent under pressure (under a load) to give a kneadate, and the kneadate is molded into a molded article and simultaneously decompressed, thus molding and expansion are performed simultaneously.

As is described above, the foamed structure may be prepared by expansion molding through the steps of impregnating the resin composition of the present invention with the blowing agent and decompressing the resulting article. Typically, the foamed structure may be prepared through the steps of molding the resin composition of the present invention to give an unfoamed resin molded article, impregnating the unfoamed resin molded article with the blowing agent, and decompressing the resulting article to expand the article. The foamed structure may also be prepared by melting the resin composition of the present invention, impregnating the molten resin composition with the blowing agent under pressure (under a load), and molding the resulting article upon decompression.

A process according to the batch system will be illustrated below.

In the batch system, an unfoamed resin molded article is initially prepared from the resin composition of the present invention. The unfoamed resin molded article may be prepared typically by: a technique of molding the resin composition of the present invention through an extruder such as a single-screw extruder or twin-screw extruder; a technique of uniformly kneading the resin composition of the present invention using a kneader equipped with one or more blades typically of a roller, cam, kneader, or Banbury type, and press-forming the kneadate typically with a hot-plate press to a predetermined thickness; or a technique of molding the resin composition of the present invention using an injection molding machine.

Next, cells are formed in the unfoamed resin molded article through a gas impregnating step and a decompressing step. In the gas impregnating step, the unfoamed resin molded article is placed in a pressure-tight case (high-pressure case), the inert gas as a blowing agent (of which carbon dioxide or nitrogen is preferred) is injected or introduced into the case, and the unfoamed resin molded article is impregnated with the gas under high pressure. In the decompressing step, at the time when being sufficiently impregnated with the gas, the unfoamed resin molded article is decompressed (generally to an atmospheric pressure) to form cell nuclei therein. Where necessary, the process may further include a heating step of heating the article to grow the cell nuclei.

After growing the cells as above, the resulting article is cooled to fix its shape and yields a foamed structure. Where necessary, the cooling may be performed abruptly typically with chilled water.

The unfoamed resin molded article is not limited in its shape and may be in the form typically of a roll, sheet, or plate. The gas as the blowing agent may be introduced continuously or discontinuously. The heating to grow the cell nuclei may be performed by a known or customary technique typically using a water bath, oil bath, hot roll, hot-air oven, far-infrared rays, near-infrared rays, or microwaves. The unfoamed resin molded article to be expanded may also be prepared by another molding technique than extrusion molding, press forming, and injection molding.

In turn, a process according to the continuous system will be illustrated below.

In the continuous system, the resin composition of the present invention is initially subjected to a kneading-impregnating step. In this step, while kneading the resin composition using an extruder, the inert gas as a blowing agent (of which carbon dioxide or nitrogen is preferred) is injected (introduced) into the extruder to impregnate the resin composition sufficiently with the gas under high pressure.

Next, a kneadate obtained from the kneading-impregnating step is subjected to a molding-decompressing step. In this step, the resin composition is extruded typically through dies provided at the extruder nose, is thereby decompressed (generally to an atmospheric pressure), and thus molding and expansion are performed simultaneously to grow cells. Where necessary the process may further include a heating step of heating the article to grow the cell nuclei.

After growing the cells as above, the resulting article is cooled to fix its shape and yields a foamed structure. The cooling may be performed abruptly typically with chilled water according to necessity.

The gas as the blowing agent may be introduced continuously or discontinuously. The heating to grow the cell nuclei may be performed by the procedure as in the batch system.

The amount of the inert gas to be incorporated in the gas impregnating step of the batch system or in the kneading-impregnating step of the continuous system is not critical, but preferably from 1 to 10 percent by weight and more preferably from 2 to 5 percent by weight, relative to the total amount (100 percent by weight) of the resin composition of the present invention, or relative to the total amount (100 percent by weight) of the unfoamed resin molded article formed from the resin composition. This range is preferred for obtaining a cell structure with a high expansion ratio.

The pressure upon the inert gas impregnation in the gas impregnating step of the batch system or in the kneading-impregnating step of the continuous system may be suitably selected in view typically of the type of the gas as the blowing agent and operability. For example, carbon dioxide, when used as the inert gas, may be subjected to impregnation at a pressure of 6 MPa or more (e.g., from 6 to 100 MPa) and more preferably 8 MPa or more (e.g., from 8 to 100 MPa). Impregnation with carbon dioxide, if performed at a pressure of less than 6 MPa, may cause excessive or significant cell growth upon expansion to give cells with excessively large diameters. This may readily cause disadvantages such as reduction in dust-proof effects, thus being undesirable. This is because as follows. When impregnation is performed under such a low pressure, the amount of the impregnated carbon dioxide gas is relatively small, and cell nuclei grow at a lower rate as compared to impregnation under a higher pressure. As a result, cell nuclei are formed in a smaller number. This increases, rather than decreases, the gas amount per cell and causes the cells to have excessively large diameters. In addition, in such a low pressure range of less than 6 MPa, only a slight change in impregnation pressure may result in considerable changes in cell diameter and cell density, and this may often impede the control of cell diameter and cell density.

The temperature upon the inert gas impregnation in the gas impregnating step of the batch system or in the kneading-impregnating step of the continuous system may be suitably selected in view of the blowing agent gas, the operability, and the formulation of the resin composition of the present invention. In particular, the resin composition of the present invention contains a thermal crosslinking agent as an essential component. The inert gas impregnation, if performed at a temperature of higher than the reaction initiation temperature of the thermal crosslinking agent, may cause the thermal crosslinking agent to form a crosslinked structure, and the crosslinked structure may act as an inhibitory factor and might impede the formation of a cell structure with a high expansion ratio. To prevent this, the inert gas impregnation is preferably performed at a temperature lower than the reaction initiation temperature of the thermal crosslinking agent.

The inert gas impregnation may be performed at a temperature of typically from 10° C. to 100° C. Particularly when the unfoamed resin molded article is impregnated with the inert gas according to the batch system, the impregnation is performed at a temperature of preferably from 10° C. to 80° C. and more preferably from 40° C. to 60° C. When the resin composition is impregnated with the inert gas according to the continuous system, the impregnation is performed at a temperature of preferably from 10° C. to 100° C. and more preferably from 10° C. to 80° C. Carbon dioxide, when employed as the inert gas, is subjected to impregnation at a temperature (impregnation temperature) of preferably 32° C. or higher and particularly preferably 40° C. or higher so as to maintain its supercritical state.

Though not critical, decompression in the decompressing step or in the molding-decompressing step may be performed at a rate of preferably from 5 to 300 MPa per second so as to obtain uniform micro cells. Heating in the heating step may be performed typically from 40° C. to 250° C. and preferably from 60° C. to 250° C.

The process can give a cell structure with a high expansion ratio and enables easy production of a thick foamed structure. This is advantageous when the resin foams according to the first to fourth embodiments of the present invention are to have large thicknesses. Typically, according to the continuous system, a gap between dies mounted on the extruder nose should be minimized (generally from 0.1 to 1.0 mm) so as to maintain the extruder inside pressure during the kneading-impregnating step. To obtain a thick foamed structure, a resin composition extruded through such a narrow gap should be expanded at a high expansion ratio. Customary techniques, however, fail to provide such a high expansion ratio, and the resulting foamed structure is limited to one having a small thickness (e.g., from about 0.5 to about 2.0 mm). In contrast, the above-mentioned process employing the inert gas as a blowing agent enables continuous formation of a foamed structure (particularly sheet-like foamed structure) having a final thickness of from 0.50 to 5.00 mm.

To give such a thick foamed structure, the foamed structure may have a relative density of preferably from 0.02 to 0.3 and more preferably from 0.05 to 0.25. The term “relative density” refers to the ratio of the density after expansion to the density before expansion. The foamed structure, if having a relative density of more than 0.3, may undergo insufficient expansion; and, if having a relative density of less than 0.02, may cause the resulting resin foam to have remarkably inferior strengths, thus being undesirable.

Though not limited in shape, thickness, and other factors, the foamed structure is preferably in the form of a sheet having a thickness of from 0.5 to 5 mm. The foamed structure may be processed into desired shape and thickness before being subjected to active energy ray irradiation and/or heating so as to form a crosslinked structure.

The thickness, density, relative density, and other factors of the foamed structure may be adjusted by suitably selecting conditions according to the formulation of the resin composition of the present invention and the type of the inert gas as the blowing agent. Exemplary conditions include temperature, pressure, time, and other operational conditions in the gas impregnating step or in the kneading-impregnating step; decompression rate, temperature, pressure, and other operational conditions in the decompressing step or in the molding-decompressing step; and heating temperature in the heating step performed after decompressing or molding-decompressing.

The crosslinked structure formation by the action of the bifunctional (meth)acrylate and the trifunctional or higher (meth)acrylate is performed by active energy ray irradiation. The active energy ray is exemplified by ionizing radiation such as alpha rays, beta rays, gamma rays, neutron beams, and electron beams; and ultraviolet rays. Ultraviolet rays and electron beams are preferred in terms of workability. Among them, electron beams are more preferred for sufficient crosslinked structure formation. Typically, electron beams are preferably employed for the formation of a crosslinked structure in a black foamed structure. The active energy ray irradiation conditions, such as irradiation energy, irradiation time, and irradiation procedure are not limited.

The foamed structure may be irradiated with the active energy ray in any manner not limited. For example, when the foamed structure is in the form of a sheet and to be irradiated with an ultraviolet ray as the active energy ray, the sheet-like foamed structure may be irradiated with the ultraviolet ray on one side up to 750 mJ/cm²; and then irradiated with the ultraviolet ray on the other side up to 750 mJ/cm². When the foamed structure is in the form of a sheet and to be irradiated with electron beams as the active energy ray, the sheet-like foamed structure may be irradiated with the electron beams to a dose of from 50 to 300 kGy.

The heating treatment allows the thermal crosslinking agent to form a crosslinked structure. The heating treatment is not limited, but is exemplified by a heating treatment of leaving the article stand at an ambient temperature of from 100° C. to 220° C. (preferably from 110° C. to 180° C., and furthermore preferably from 120° C. to 170° C.) for a duration of from 10 minutes to 10 hours (preferably from 30 minutes to 8 hours, and furthermore preferably from one hour to 5 hours). Such ambient temperature may be obtained typically by a known heating procedure such as heating with an electric heater, heating with electromagnetic waves such as infrared rays, and heating on a water bath.

The resin foams according to the first to fourth embodiments of the present invention are advantageously used typically as or for internal insulators in electronic appliances and other articles, cushioning materials, sound insulators, heat insulators, food packaging materials, clothing materials, and building materials.

### EXAMPLES

The present invention will be illustrated in further detail with reference to several examples below, which are by no means intended to limit the scope of the invention.

### Example 1

A resin composition was obtained by charging material into a two-bladed compact 10-L dispersion kneader (supplied by Toshin Co., Ltd.) and kneading them at a temperature of 80° C. for 40 minutes. The materials were 100 parts by weight of an acrylic elastomer, 30 parts by weight of a bisphenol-A-EO-modified diacrylate (supplied under the trade name of “NK Ester A-BPE30” by Shin-Nakamura Chemical Co., Ltd., an ethoxylated bisphenol-A diacrylate), 45 parts by weight of trimethylolpropane triacrylate (supplied under the trade name of “NK Ester TMPT” by Shin-Nakamura Chemical Co., Ltd.), 50 parts by weight of magnesium hydroxide (supplied under the trade name of “EP1-A” by Konoshima Chemical Co., Ltd.) as inorganic particles, 2 parts by weight of hexamethylenediamine (supplied under the trade name of “diak NO. 1” by E. I. du Pont de Nemours & Co.) as an elastomer crosslinking agent, 2 parts by weight of 1,3-di-o-tolylguanidine (supplied under the trade name of “Nocceler DT” by Ouchi Shinko Chemical Industrial Co., Ltd.) as an elastomer crosslinking coagent, 10 parts by weight of carbon black (supplied under the trade name of “#35” by Asahi Carbon Co., Ltd.), and 8 parts by weight of a bifunctional processing stabilizer (supplied under the trade name of “SUMILIZER GM,” a phenolic age inhibitor). The acrylic elastomer included 85 parts by weight of butyl acrylate, 15 parts by weight of acrylonitrile, and 6 parts by weight of acrylic acid as monomer components and had an acrylic acid content of 5.67 percent by weight and a weight-average molecular weight of 217×10⁴ in terms of a polystyrene standard (in terms of PS).

The resin composition was charged into a single-screw extruder. At a temperature of 60° C., while kneading the resin composition, carbon dioxide gas was injected (introduced) into the single-screw extruder in such a gas amount as to be 4 percent by weight relative to the total amount (100 percent by weight) of the resin composition and at a fed gas pressure of 28 MPa. These were mixed and kneaded with each other so as to impregnate the resin composition sufficiently with the carbon dioxide gas.

Next, the resin composition was extruded through a circular die arranged at the single-screw extruder nose into the atmosphere, thereby decompressed to the atmospheric pressure, expanded through simultaneous molding and expansion, and yielded a sheet-like foamed structure.

This step corresponds to the molding-decompressing step and includes extruding the resin composition from the single-screw extruder, thereby decompressing the resin composition to the atmospheric pressure, and thus expanding the resin composition through simultaneous molding and expansion.

The above-obtained sheet-like foamed structure was irradiated on both sides with electron beams at an acceleration voltage of 250 kV to a dose of 200 kGy to form a crosslinked structure. After the electron beam irradiation, the resulting article was further subjected to a heating treatment by leaving the same stand at an ambient temperature of 170° C. for one hour to further form a crosslinked structure.

Thus, a sheet-like resin foam was obtained.

### Example 2

A resin composition was obtained by the procedure of Example 1 and charged into a single-screw extruder. Carbon dioxide gas was injected (introduced) into the single-screw extruder in such a gas amount as to be 3.2 percent by weight relative to the total amount (100 percent by weight) of the resin composition. Molding and expansion were performed simultaneously by the procedure of Example 1 and yielded a sheet-like foamed structure.

Next, the sheet-like foamed structure was irradiated with electron beams by the procedure of Example 1 to form a crosslinked structure. The resulting article was further subjected to a heating treatment by leaving the same stand at an ambient temperature of 210° C. for 5 minutes to further form a crosslinked structure.

Thus, a sheet-like resin foam was obtained.

### Example 3

A resin composition was obtained by the procedure of Example 1 and charged into a single-screw extruder. Carbon dioxide gas was injected (introduced) into the single-screw extruder in such a gas amount as to be 3.3 percent by weight relative to the total amount (100 percent by weight) of the resin composition. Molding and expansion were performed simultaneously by the procedure of Example 1 and yielded a sheet-like foamed structure.

Next, the sheet-like foamed structure was irradiated with electron beams by the procedure of Example 1 to form a crosslinked structure. The resulting article was further subjected to a heating treatment by leaving the same stand at an ambient temperature of 210° C. for 5 minutes to further form a crosslinked structure.

Thus, a sheet-like resin foam was obtained.

### Example 4

A resin composition was obtained by charging materials into a two-bladed compact 10-L dispersion kneader (supplied by Toshin Co., Ltd.) and kneading them at a temperature of 80° C. for 40 minutes. The materials were 100 parts by weight of an acrylic elastomer, 30 parts by weight of a polypropylene glycol diacrylate (supplied under the trade name of “ARONIX M-270” by Toagosei Co., Ltd.), 45 parts by weight of trimethylolpropane triacrylate (supplied under the trade name of “NK Ester TMPT” by Shin-Nakamura Chemical Co., Ltd.), 50 parts by weight of magnesium hydroxide (supplied under the trade name of “EP1-A” by Konoshima Chemical Co., Ltd.) as inorganic particles, 2 parts by weight of hexamethylenediamine (supplied under the trade name of “diak NO. 1” by E. I. du Pont de Nemours & Co.) as an elastomer crosslinking agent, 2 parts by weight of 1,3-di-o-tolylguanidine (supplied under the trade name of “Nocceler DT” by Ouchi Shinko Chemical Industrial Co., Ltd.) as an elastomer crosslinking coagent, 10 parts by weight of carbon black (supplied under the trade name of “#35” by Asahi Carbon Co., Ltd.), and 8 parts by weight of a bifunctional processing stabilizer (supplied under the trade name of “SUMILIZER GM,” a phenolic age inhibitor). The acrylic elastomer included 85 parts by weight of butyl acrylate, 15 parts by weight of acrylonitrile, and 6 parts by weight of acrylic acid as monomer components and had an acrylic acid content of 5.67 percent by weight and a weight-average molecular weight of 217×10⁴ in terms of a polystyrene standard (in terms of PS).

Next, a sheet-like foamed structure was prepared from the above-obtained resin composition by the procedure of Example 1, except for using the gas in an amount of 4 percent by weight.

The sheet-like foamed structure was further subjected to crosslinked structure formation by the procedure of Example 1 and yielded a sheet-like resin foam.

### Comparative Example 1

A resin composition was obtained by charging materials into a twin-screw kneader, kneading them thoroughly at a temperature of 200° C. to give a kneadate, extruding the kneadate into strands, cooling the strands with water, and molding the strands by cutting the same into pellets. The materials were 50 parts by weight of a thermoplastic elastomer composition, 50 parts by weight of a polypropylene, 10 parts by weight of a lubricant composition, and 50 parts by weight of magnesium hydroxide as a nucleating agent. The thermoplastic elastomer composition was a blend (TPO) of a polypropylene (PP) and an ethylene/propylene/5-ethylidene-2-norborneneternary copolymer (EPT) and included carbon black.

The pelletized resin composition was charged into a single-screw extruder. At an ambient temperature of 220° C., carbon dioxide gas was injected at a pressure of 25 MP into the single-screw extruder while kneading the resin composition. After being sufficiently saturated with the carbon dioxide gas, the resin composition was extruded through dies provided at the single-screw extruder nose, thereby decompressed to the atmospheric pressure, expanded through simultaneous molding and expansion, and yielded a sheet-like resin foam.

### Comparative Example 2

A commercially available (sheet-like) resin foam including a polyurethane as a principal component was used.

### Comparative Example 3

A resin composition was obtained by charging material into a two-bladed compact 10-L dispersion kneader (supplied by Toshin Co., Ltd.) and kneading them at a temperature of 80° C. for 40 minutes. The materials were 100 parts by weight of an acrylic elastomer, 75 parts by weight of trimethylolpropane triacrylate (supplied under the trade name of “NK Ester TMPT” by Shin-Nakamura Chemical Co., Ltd.), 50 parts by weight of magnesium hydroxide (supplied under the trade name of “EP1-A” by Konoshima Chemical Co., Ltd.) as inorganic particles, 2 parts by weight of hexamethylenediamine (supplied under the trade name of “diak NO. 1” by E. I. du Pont de Nemours & Co.) as an elastomer crosslinking agent, 2 parts by weight of 1,3-di-o-tolylguanidine (supplied under the trade name of “Nocceler DT” by Ouchi Shinko Chemical Industrial Co., Ltd.) as an elastomer crosslinking coagent, 10 parts by weight of carbon black (supplied under the trade name of “#35” by Asahi Carbon Co., Ltd.), and 8 parts by weight of a bifunctional processing stabilizer (supplied under the trade name of “SUMILIZER GM,” a phenolic age inhibitor). The acrylic elastomer included 85 parts by weight of butyl acrylate, 15 parts by weight of acrylonitrile, and 6 parts by weight of acrylic acid as monomer components and had an acrylic acid content of 5.67 percent by weight and a weight-average molecular weight of 217×10⁴ in terms of a polystyrene standard (in terms of PS).

A sheet-like resin foam was obtained from the above-obtained resin composition by the procedure of Example 1.

Evaluations

The resin foams obtained in the examples and comparative examples were subjected to measurements or evaluations as follows. The results are indicated in Tables 1 and 2.

Thickness (Initial Thickness)

The thickness (initial thickness) (μm) of each resin foam was measured with a 1/100-scale dial gauge having a measuring terminal 20 mm in diameter.

Density (Apparent Density))

Each resin foam was subjected to blanking (die cutting) to give a 20-mm wide, 20-mm long specimen. The specific gravity of the specimen was measured with an electronic densimeter (supplied under the trade name of “MD-200S” by Alfa Mirage Co., Ltd.), from which the density (g/cm³) of the specimen was determined.

Average Cell Diameter

The average cell diameter (μm) of each resin foam was determined in a manner as follows.

The average cell diameter was determined with a digital microscope (supplied under the trade name of “VHX-600” by Keyence Corporation) by capturing an image of a cell-structure region of the resin foam cross section, measuring areas of all cells appearing in a predetermined area (1 mm²) of the cross cut section, converting the measured areas into equivalent circle diameters, and summing up and averaging the diameters by the number of cells.

The image analysis was performed using an image analyzing software (supplied under the trade name of “WIN ROOF” by Mitani Corporation).

Compression Load upon 50% Compression (50% compression load, compressive hardness upon 50% compression)

The compression load upon 50% compression was determined through measurement according to the compressive hardness measuring method described in JIS K 6767.

Specifically, each resin foam was cut to give 1-mm thick, 20-mm diameter round specimens.

Next, at an ambient temperature of 23° C., the specimens were compressed in a thickness direction to a thickness of 50% of the initial thickness and held in the compressed state for 20 seconds. The specimens were subsequently decompressed, loads (N) were measured 20 seconds after the decompression, the measured loads were converted into values per unit area (1 cm²), and the values were each defined as the compression load upon 50% compression (N/cm²).

The compression load upon 50% compression was determined on two specimens, i.e., a specimen after aging at 23° C.; and a specimen after the aging and subsequent leaving stand in an oven at 200° C. for one hour. In Table 1, the “compression load upon 50% compression of the specimen after aging at 23° C.” is indicated in “before heating” of “compression load upon 50% compression”; and the “compression load upon 50% compression of the specimen after the aging and leaving left in an oven at 200° C. for one hour” is indicated in “after heating” of “compression load upon 50% compression.”

Thickness Recovery Rate (23° C., one minute, 50% compression)

Each resin foam was cut to give a 1-mm thick, 25-mm square sheet-like specimen.

The thickness recovery rate (23° C., one minute, 50% compression) was determined in a manner as follows. The specimen was compressed in a thickness direction to a thickness of 50% of the initial thickness at an ambient temperature of 23° C. and held in the compressed state at 23° C. for one minute using an electromagnetic force micro material tester (Micro-Servo) (“MMT-250” supplied by Shimadzu Corporation). After decompressing the specimen, pictures of a thickness recovery behavior (thickness change, thickness recovery) were taken with a high-speed camera, and a thickness one second after the decompression was determined from the taken pictures. Next, the thickness recovery rate (23° C., one minute, 50% compression) (%) was determined according to an expression as follows:

Thickness recovery rate(23° C.,one minute,50% compression)=(Thickness one second after the decompression)/(Initial thickness)×100

Strain Recovery Rate (80° C., 24 hours, 50% compression)

Each resin foam was cut to give a 1-mm thick, 25-mm square sheet-like specimen.

The specimen was compressed to a thickness of 50% of the initial thickness using a spacer and stored in this state (decompressed state) at 80° C. for 24 hours. Twenty-four (24) hours later, the specimen was returned to 23° C. while being held in the compressed state, and subsequently decompressed. The thickness of the specimen was accurately measured 24 hours after the decompression. The ratio of the recovered distance to the compressed distance was determined according to an expression and was defined as the strain recovery rate (80° C., 24 hours, 50% compression) (%), the expression expressed as follows:

Strain recovery rate(80° C.,24 hours,50% compression)(%)=(c−b)/(a−b)×100

where:

“a” represents the specimen's thickness;

“b” represents a thickness half the specimen's thickness; and “c” represents the specimen's thickness after decompression.

Variation in Impact Absorption Rate

Each resin foam was cut to give two 1-mm thick, 20-mm square sheet-like specimens.

At an ambient temperature of 23° C., one of the specimens was compressed in a thickness direction to a thickness of 50% of the initial thickness and held in the compressed state for 5 minutes. The specimen was subsequently decompressed and yielded Specimen A. The impact absorption rate of Specimen A was determined by an impact absorption rate measuring method mentioned below.

Next, at an ambient temperature of 180° C., the other of the specimens was compressed in a thickness direction to a thickness of 50% of the initial thickness and held in the compressed state for 5 minutes. The specimen was subsequently decompressed and yielded Specimen B. The impact absorption rate of Specimen B was determined by the impact absorption rate measuring method.

An absolute value of the difference in impact absorption rate between Specimen A and Specimen B was determined and defined as the variation in impact absorption rate.

The impact absorption rate (%) of each specimen was determined in a manner as follows. Using a pendulum impact tester illustrated in FIG. 1, an impact force where no specimen was inserted (impact force of the supporting plate and the acrylic plate alone) (blank value) was measured as F0; whereas an impact force where the specimen was inserted into between the supporting plate and the acrylic plate was measured as F1; and the impact absorption rate (%) was calculated according to an expression as follows:

Impact absorption rate (%)—(F0−F1)/F0×100

FIG. 1 is a schematic diagram illustrating the pendulum impact tester where the specimen is inserted. In FIG. 1, reference signs 1 stands for the pendulum impact tester; 11 stands for a load cell; 12 stands for the specimen; 13 stands for the acrylic plate; 14 stands for an iron ball; 15 stands for a pressing-force controller; 16 stands for the supporting plate; 17 stands for a supporting shaft; and 18 stands for a pendulum arm. The load cell 11 has a pressure sensor sensing an impact force upon collision with the iron ball 14 and can measure a specific value of impact force. With reference to FIG. 1, the specimen 12 was placed between the acrylic plate 13 and the supporting plate 16 at a position corresponding to the load cell. The pressing-force controller 15 controlled the compression rate of the specimen 12. The iron ball 14 acted as an impactor and had a diameter of 19.5 mm and a weight of 40-gram weight (0.39 N). The iron ball 14 was raised to and once fixed at a dropping angle (rise angle) of 40°, and then dropped.

Rate of Dimensional Change

Each resin foam was cut to give an about 100-mm square sheet-like specimen. Using digital vernier calipers, dimensions of the specimen in the longitudinal direction (machine direction; MD), crosswise direction (CD; transverse direction (TD)), and thickness direction were measured.

Next, the specimen was left stand in an oven at 200° C. for one hour. One hour later, the specimen was retrieved from the oven, and the dimensions of the specimen in the machine direction, crosswise direction, and thickness direction were measured by the procedure as above.

The rates of dimensional change of the dimensions in the machine direction, crosswise direction, and thickness direction were calculated respectively according to an expression as follows:

Rate of dimensional change (%)=(L0−L1)/L0×100

where:

L0 represents the initial specimen's dimension (blank value); and

L1 represents the specimen's dimension after left stand at 200° C. for one hour.

Rate of Weight Change

Each resin foam was cut to give a 1-mm thick, 100-mm square sheet-like specimen. The weight of the specimen was measured using an electronic balance.

Next, the specimen was left stand in an oven at 200° C. for one hour. One hour later, the specimen was retrieved from the oven, and the weight thereof was measured using the electronic balance by the procedure as above.

Based on these data, the rate of weight change was calculated according to an expression as follows:

Rate of weight change (%)=(W0−W1)/W0×100

where:

W0 represents the initial specimen's weight (blank value); and

W1 represents the specimen's weight after left stand at 200° C. for one hour.

Total Luminous Transmittance

A 0.6-mm thick, 30-mm square sheet-like specimen was prepared from each resin foam.

The total luminous transmittance of the specimen was measured according to JIS K 7361 using a haze meter (supplied under the trade name of “HM-150” by Murakami Color Research Laboratory).

Light-Blocking Effect

A 1-mm thick sheet-like specimen was prepared from each resin foam.

This specimen was placed so that a side of the specimen to be irradiated with light was brought into intimate contact with a backlight (light source: LED or fluorescent lamp). The specimen was irradiated with light, whether there was a pinhole was observed based on light passing through the sheet-like specimen, and the size of such pinhole, if any, was measured.

The light-blocking effect of the specimen was evaluated according to criteria as follows:

Good (Good): There was no pinhole at all, or, if any, there was no pinhole having a size of 1 mm or more; and

Poor (x): There was one or more pinholes having a size of 1 mm or more.

Degree of Blackness

A 1-mm thick sheet-like specimen was prepared from each resin foam.

The degree of blackness of the specimen was measured using a handy spectrophotometric type color difference meter (supplied under the device name of “NF333” by Nippon Denshoku Industries Co., Ltd.).

Dynamic Dust-Proofness

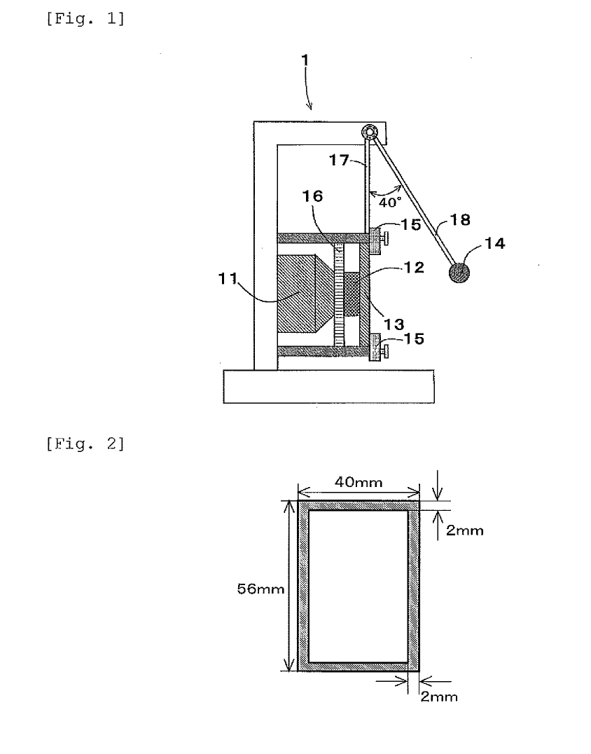

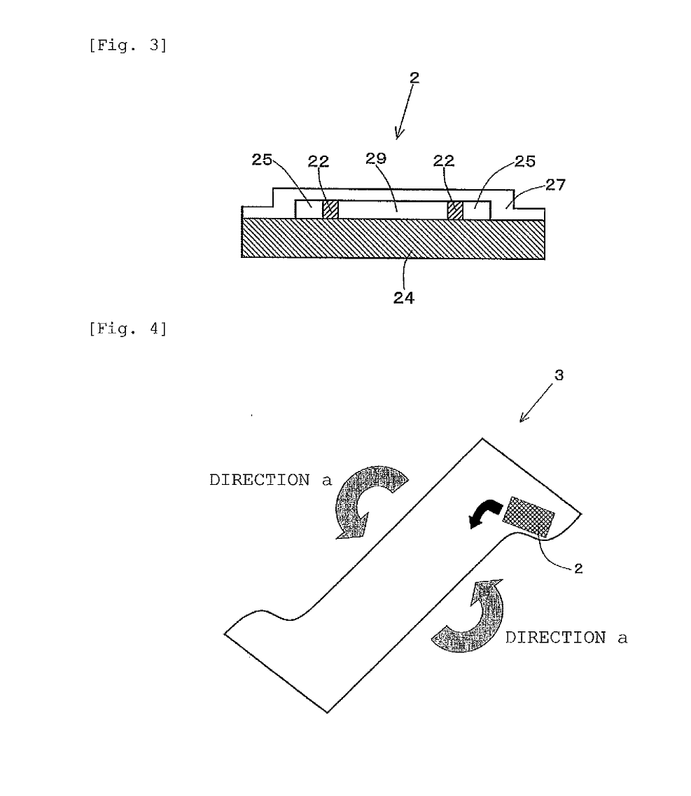

Each resin foam was punched to give a frame-like evaluation sample (see FIG. 2). With reference to FIGS. 3 and 5, the evaluation sample was assembled to an evaluation chamber (dynamic dust-proofness evaluation chamber mentioned below, see FIGS. 3 and 5). Next, particulate matter was fed to outside of the evaluation sample (powder-supply area) in the evaluation chamber, and the evaluation chamber to which the particulate matter was fed was placed in a tumbler (tumbling barrel), and the tumbler was rotated counterclockwise to load impact to the evaluation chamber repeatedly.

FIG. 3 is a simple schematic cross-sectional view of the dynamic dust-proofness evaluation chamber assembled with the evaluation sample. In FIG. 3, reference signs 2 stands for the evaluation chamber assembled with the evaluation sample (package assembled with the evaluation sample); 22 stands for evaluation sample (resin foam punched into a frame); 24 stands for a base plate; 25 stands for the powder-supply area; 27 stands for a foam-compressing board; and 29 stands for the evaluation chamber internal space (package inside). In the evaluation chamber assembled with the evaluation sample illustrated in FIG. 3, the evaluation sample 22 partitioned the powder-supply area 25 and the evaluation chamber internal space 29 from each other, and the powder-supply area 25 and the evaluation chamber internal space 29 formed closed systems, respectively.

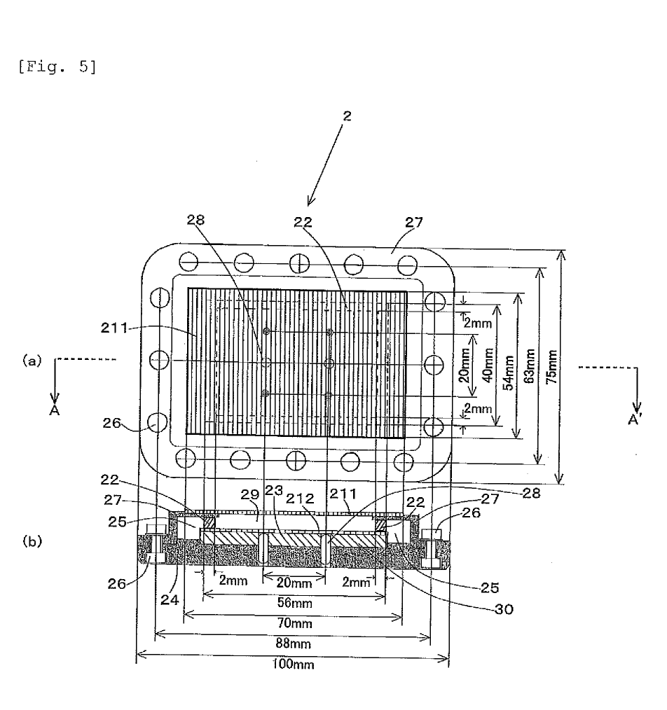

FIG. 4 is a schematic cross-sectional view illustrating the tumbler in which the evaluation chamber was placed. In FIG. 4, reference signs 3 stands for the tumbler; 2 stands for the evaluation chamber assembled with the evaluation sample; and the direction “a” stands for the tumbler rotating direction. The rotation of the tumbler 3 loaded impact to the evaluation chamber 2 repeatedly.

How to evaluate the dynamic dust-proofness will be illustrated in further detail below.

Each resin foam was punched to give a frame-like (window-frame-like) evaluation sample with a frame width of 2 mm.

With reference to FIGS. 3 and 5, the evaluation sample was installed to the evaluation chamber (dynamic dust-proofness evaluation chamber, see FIGS. 3 and 5). The compression rate of the evaluation sample upon installation was 50% (the sample was compressed to 50% of the initial thickness).

With reference to FIG. 5, the evaluation sample was placed between the foam-compressing board and the black acrylic plate arranged over the aluminum plate that was fixed to the base plate. The evaluation sample formed a closed system in a predetermined area inside of the evaluation chamber installed with the evaluation sample.

The evaluation sample was installed to the evaluation chamber as illustrated in FIG. 5, 0.1 g of corn starch (particle size: 17 μm) as dust particles was placed in the powder-supply area, the evaluation chamber was placed in the tumbler (tumbling barrel, drum drop tester), and the tumbler was rotated at a speed of 1 rpm.

The tumbler was rotated predetermined times so as to provide 100 collisions (repeated impacts), and the package was disassembled. Particles passing from the powder-supply area through the evaluation sample and deposited on the black acrylic plate facing the aluminum plate and on the black acrylic plate serving as the cover plate were observed with a digital microscope (supplied under the device name of “VHX-600” by Keyence Corporation). Static images of the black acrylic plate facing the aluminum plate and of the black acrylic plate serving as the cover plate were produced, the images were binarized using an image analyzing software (supplied under the software name of “Win ROOF” by Mitani Corporation), based on which the total area of particles was measured. The total particle area was divided by a particle area (area per one particle) to calculate the number of particles. The observation was performed in a clean bench so as to reduce the influence of air-borne dust.

A sample having a total particle number of 50×10⁴ or less was evaluated as having good dynamic dust-proofness; whereas a sample having a total particle number of more than 50×10⁴ was evaluated as having poor dynamic dust-proofness. The “total particle number” refers to the total sum of the number of particles deposited on the black acrylic plate facing the aluminum plate and the number of particles deposited on the black acrylic plate serving as the cover plate.

FIG. 5 depict a top view and a cut end view of the evaluation chamber assembled with the evaluation sample (dynamic dust-proofness evaluation chamber). FIGS. 5(a) and 5(b) depict a top view and a cut end view along line A-A′, respectively, of the dynamic dust-proofness evaluation chamber assembled with the evaluation sample. The dynamic dust-proofness (dust-proofness upon impact) of the evaluation sample can be evaluated by assembling the evaluation sample to the evaluation chamber and dropping the evaluation chamber. In FIG. 5, reference signs 2 stands for the evaluation chamber assembled with the evaluation sample; 211 stands for the black acrylic plate (black acrylic plate serving as the cover plate); 212 stands for the black acrylic plate (black acrylic plate facing the aluminum plate); 22 stands for the evaluation sample (frame-like resin foam); 23 stands for the aluminum plate; 24 stands for the base plate; 25 stands for the powder-supply area; 26 stands for a screw; 27 stands for the foam-compressing board; 28 stands for a pin; 29 stands for the evaluation chamber internal space; and 30 stands for the aluminum spacer. The compression rate of the evaluation sample 22 can be controlled by regulating the thickness of the aluminum spacer 30. In the dynamic dust-proofness evaluation chamber assembled with the evaluation sample, a cover-plate-fixing bracket was provided between screws facing each other and firmly fixed the black acrylic plate 211 to the foam-compressing board 27, although the fixing bracket is not shown in the top view FIG. 5(a).

TABLE 1

| | | | | | | Comparative | Comparative | Comparative |
|---|---|---|---|---|---|---|---|---|
| | | Example 1 | Example 2 | Example 3 | Example 4 | Example 1 | Example 2 | Example 3 |
| Thickness (mm) | | 1 | 1 | 1 | 1 | 1 | 1 | 1 |
| Average cell diameter (μm) | | 144 | 137 | 195 | 195 | 100 | 70-80 | 371 |
| Density (g/cm³) | | 0.078 | 0.083 | 0.068 | 0.08 | 0.05 | 0.15 | 0.051 |
| Compression load upon | Before heating | 0.7 | 1.27 | 0.8 | 0.4 | 1.55 | 1.0 | 0.45 |
| 50% compression (N/cm²) | After heating | — | 2.10 | — | — | Incompressible | — | — |
| Thickness recovery rate | | 85 | 76 | 81 | 70< | 93 | 65 | 70< |
| (23° C., one minute, 50% compression) (%) | | | | | | | | |
| Strain recovery rate | | 92 | 94 | 90 | 90 | 0 | 99 | 80< |
| (80° C., 24 hrs, 50% compression) (%) | | | | | | | | |
| Variation in impact absorption rate (%) | | 0.3 | 0.0 | 0.7 | 0-1 | 26.5 | 5.8 | 0-1 |
| Total luminous transmittance (%) | | 0 | 0 | 0 | 0 | 0 | 0 | 10< |
| Dynamic dust- | Total particle | 125890 | 150570 | 230576 | — | 330461 | 100 × 10⁴< | 100 × 10⁴< |
| proofness | number | | | | | | | |
| | Evaluation | Good | Good | Good | — | Good | Poor | Poor |

| | | | | | | | |
|---|---|---|---|---|---|---|---|
| Light-blocking effect | Good | Good | Good | Good | Good | Good | Poor |
| Degree of blackness L* | 24.21 | 20.91 | 22.26 | 26.64 | 35.50 | 26.45 | 23.90 |

In Table 1, the symbol “-” indicates that no measurement was performed.

A sample having a compression load upon 50% compression of less than 2.5 N/cm² can be evaluated as having a superior shock absorbing function. The specimen after heating of Comparative Example 1 was immeasurable on the compression load upon 50% compression, because the specimen could not be compressed to 50% of the initial thickness. The specimen of Comparative Example 1 could be evaluated as losing flexibility due to heating.

TABLE 2

| | | | | Rate of dimensional change | | | | | | | | |
|---|---|---|---|---|---|---|---|---|---|---|---|---|
| | Rate of weight change | | | MD | | | TD | | | Thickness direction | | |
| | | | Rate of | | | Rate of | | | Rate of | | | Rate of |
| | W0 | W1 | change | L0 | L1 | change | L0 | L1 | change | L0 | L1 | change |
| | (g) | (g) | (%) | (mm) | (mm) | (%) | (mm) | (mm) | (%) | (mm) | (mm) | (%) |
| Example 2 | 0.79 | 0.78 | 1.54 | 100.00 | 100.00 | 0.00 | 100.00 | 100.00 | 0.00 | 0.88 | 0.87 | 1.70 |
| Comparative | 0.61 | 0.50 | 17.50 | 100.00 | 36.50 | 63.50 | 100.00 | 34.40 | 65.80 | 1.24 | 0.06 | 95.39 |
| Example 1 | | | | | | | | | | | | |
| Comparative | 1.3 | 1.2 | 2.6 | 99.5 | 99.2 | 0.3 | 100.0 | 99.5 | 0.5 | 1.0 | 0.6 | 35.4 |
| Example 2 | | | | | | | | | | | | |
| Comparative | 0.68 | 0.65 | 3.77 | 100.00 | 98.90 | 1.10 | 100.00 | 98.90 | 1.10 | 2.25 | 2.24 | 0.44 |
| Example 3 | | | | | | | | | | | | |

### INDUSTRIAL APPLICABILITY

The resin foams according to embodiments the present invention are useful typically for or as internal insulators in electronic appliances and other articles, cushioning materials, sound insulators, heat insulators, food packaging materials, clothing materials, and building materials.

### REFERENCE SIGNS LIST

11 load cell
12 specimen
13 acrylic plate
14 iron ball
15 pressing-force controller
16 supporting plate
17 supporting shaft
18 pendulum arm
3 tumbler
2 evaluation chamber assembled with evaluation sample
211 black acrylic plate
212 black acrylic plate
22 evaluation sample
23 aluminum plate
24 base plate
25 powder-supply area
26 screw
27 foam-compressing board
28 pin
29 evaluation chamber internal space
30 aluminum spacer

1. A resin foam having a thickness recovery rate (23° C., one minute, 50% compression) as defined below of 70% or more and a strain recovery rate (80° C., 24 hours, 50% compression) as defined below of 80% or more,
wherein:
the thickness recovery rate (23° C., one minute, 50% compression) is specified as a value determined by compressing the resin foam at 23° C. by 50% of an initial thickness thereof, holding the resin foam in the compressed state at 23° C. for one minute, subsequently decompressing the resin foam, measuring a thickness of the resin foam one second after the decompression, and calculating, as the thickness recovery rate, a percentage of the measured thickness with respect to the initial thickness; and
the strain recovery rate (80° C., 24 hours, 50% compression) is specified as a value determined by compressing the resin foam at 23° C. by 50% of an initial thickness thereof, holding the resin foam in the compressed state at 80° C. for 24 hours, returning the resin foam to 23° C. while maintaining the resin foam in the compressed state, subsequently decompressing the resin foam, determining a compressed distance and a recovered distance, and calculating, as the strain recovery rate, a percentage of the recovered distance with respect to the compressed distance.

2. The resin foam according to claim 1, having a thickness of from 0.1 to 5 mm and an average cell diameter of from 10 to 200 μm.

3. The resin foam according to claim 1, having a variation in impact absorption rate as defined below of 5% or less,
wherein:
the impact absorption rate (%) is specified by an expression as follows:
Impact absorption rate (%)=(F0−F1)/F0×100
where:
F0 represents a value determined by preparing a laminate including a supporting plate and an acrylic plate, bringing a steel ball into collision with the acrylic plate side of the laminate, measuring an impact force received by the supporting plate, and defining the measured impact force as F0; and
F1 represents a value determined by preparing a 1-mm thick sheet-like specimen from the resin foam, preparing a laminate including a supporting plate and an acrylic plate, inserting the specimen into between the supporting plate and the acrylic plate in the laminate, bringing a steel ball into collision with the acrylic plate side of the laminate, measuring an impact force received by the supporting plate, and defining the measured impact force as F1; and
the variation in impact absorption rate is specified as an absolute value of a difference in impact absorption rate (%) between two specimens of the resin foam, where one specimen undergoes compression at 23° C. for 5 minutes by 50% of an initial thickness thereof and subsequent decompression; and the other specimen undergoes compression at 180° C. for 5 minutes by 50% of an initial thickness thereof and subsequent decompression.

4. A resin foam having a variation in impact absorption rate as defined below of 5% or less,
wherein:
the impact absorption rate (%) is specified by an expression as follows:
Impact absorption rate (%)=(F0−F1)/F0×100
where:
F0 represents a value determined by preparing a laminate including a supporting plate and an acrylic plate, bringing a steel ball into collision with the acrylic plate side of the laminate, measuring an impact force received by the supporting plate, and defining the measured impact force as F0; and
F1 represents a value determined by preparing a 1-mm thick sheet-like specimen from the resin foam, preparing a laminate including a supporting plate and an acrylic plate, inserting the specimen into between the supporting plate and the acrylic plate in the laminate, bringing a steel ball into collision with the acrylic plate side of the laminate, measuring an impact force received by the supporting plate, and defining the measured impact force as F1; and
the variation in impact absorption rate is specified as an absolute value of a difference in impact absorption rate (%) between two specimens of the resin foam, where one specimen undergoes compression at 23° C. for 5 minutes by 50% of an initial thickness thereof and subsequent decompression; and the other specimen undergoes compression at 180° C. for 5 minutes by 50% of an initial thickness thereof and subsequent decompression.

5. A resin foam having a rate of dimensional change as defined below of 30% or less after left stand at an ambient temperature of 200° C. for one hour and having a rate of weight change as defined below of 15 percent by weight or less after left stand at an ambient temperature of 200° C. for one hour,
wherein:
the rate of dimensional change is specified as a value determined by preparing a sheet-like specimen having a width of 100 mm, a length of 100 mm, and a thickness of from 0.5 to 2 mm from the resin foam, measuring rates of dimensional change in a crosswise direction, a longitudinal direction, and a thickness direction, respectively, and defining a highest rate of dimensional change among the rates of dimensional change in these directions as the rate of dimensional change.

6. The resin foam according to claim 1, having a total luminous transmittance of 10% or less.

7. A resin foam having a total luminous transmittance of 10% or less, a density of from 0.01 to 0.8 g/cm³, and a strain recovery rate (80° C., 24 hours, 50% compression) as defined below of 80% or more;
wherein the strain recovery rate (80° C., 24 hours, 50% compression) is specified as a value determined by compressing the resin foam at 23° C. by 50% of an initial thickness thereof, holding the resin foam in the compressed state at 80° C. for 24 hours, returning the resin foam to 23° C. while maintaining the resin foam in the compressed state, decompressing the resin foam, measuring a recovered distance of the resin foam, determining a compressed distance and a recovered distance, and calculating, as the strain recovery rate, a percentage of the recovered distance with respect to the compressed distance.
